(19) United States
(12) Patent Application Publication
(10) Pub. No.: US 2013/0060635 A1
(43) Pub. Date: Mar. 7, 2013

(54) SYSTEM AND METHOD FOR MANAGING AND REDEEMING OFFERS WITH A LOCATION-BASED SERVICE

(71) Applicants: Tristan Walker, Palo Alto, CA (US); Noah Weiss, New York, NY (US); Jason Liszka, New York, NY (US); Tim Julien, New York, NY (US)

(72) Inventors: Tristan Walker, Palo Alto, CA (US); Noah Weiss, New York, NY (US); Jason Liszka, New York, NY (US); Tim Julien, New York, NY (US)

(21) Appl. No.: 13/408,150

(22) Filed: Feb. 29, 2012

Related U.S. Application Data
(60) Provisional application No. 61/449,233, filed on Mar. 4, 2011.
(60) Provisional application No. 61/450,616, filed on Mar. 8, 2011.

(51) Int. Cl. G06Q 30/02

(52) U.S. Cl. 705/14.58

(57) ABSTRACT

A location-based service is provided that may be integrated with venue systems, credit card processing systems, and/or loyalty systems for purposes of increasing the likelihood that offers will be accepted and sales of products and services will be made. Such a system according to various embodiments may leverage a social network of the user, and extend particular brand loyalties throughout the social network. That is, certain offers may be passed among users of the social network, permitting others to take advantage of offers thereby increasing the brand awareness and loyalty of particular venues. Further, according to certain embodiments, because an offer management and redemption system may be integrated with a location-based service, offers may be extended at or near the venue location. To this end, users may be provided one or more tools for accepting, purchasing and/or redeeming offers.

### RELATED APPLICATIONS

This application claims priority under 35 U.S.C. §119(e) to U.S. Provisional Patent Application Ser. No. 61/449,233, entitled “SYSTEM AND METHOD FOR MANAGING AND REDEEMING OFFERS WITH A LOCATION-BASED SERVICE,” filed on Mar. 4, 2011, which application is herein incorporated by reference in its entirety. This application also claims priority under 35 U.S.C. §119(e) to U.S. Provisional Patent Application Ser. No. 61/450,616, entitled “SYSTEM AND METHOD FOR PROVIDING RECOMMENDATIONS WITH A LOCATION-BASED SERVICE,” filed on Mar. 8, 2011, which application is herein incorporated by reference in its entirety.

### BACKGROUND

There are many location-based systems in use today. In particular, location-based services such as the Foursquare system (available on the Internet at http://www.foursquare.com) permit users to verify their locations using one or more computer systems. Some services permit users to use their locations for the purpose of interacting within a social network. For instance, within one type of location-based social network, users are permitted to “check in” to particular locations, including venues such as businesses, retail locations, points of interest, or other locations. Such location-based social networks permit users to interact with friends, find venues of interest, leave comments regarding particular venues, among other functions.

### SUMMARY

It may be useful and particularly advantageous to third party providers to engage customers using location-based services. Although location-based advertisements using location-based services are known, it would be beneficial to more adequately engage customers using a location-based service. Further, it is appreciated that it may be more effective to make offers to and otherwise engage a user while the user is located at or near the venue location, as the user is more likely to accept an offer at that particular location.

To this end, a location-based service may be provided that may be integrated with venue systems, credit card processing systems, and/or loyalty systems for purposes of increasing the likelihood that offers will be accepted and sales of products and services will be made. Such a system according to various embodiments may leverage a social network of the user, and extend particular brand loyalties throughout the social network. That is, certain offers may be passed among users of the social network, permitting others to take advantage of offers thereby increasing the brand awareness and loyalty of particular venues. For instance, in one embodiment, a first user may send another user within his/her social network an indication of an offer that may be available. In another example, a user may be provided the ability to permit other users in his/her social network to redeem offers originally made to the user.

Further, according to certain embodiments, because an offer management and redemption system may be integrated with a location-based service, offers may be extended at or near the venue location. To this end, users may be provided one or more tools for accepting, redeeming, and fulfilling offers. Further, tools may be provided for making an associated purchase, and fulfilling that purchase (e.g., receiving goods or services at a venue location).

According to one embodiment, offers are made to loyalty cardholders having loyalty program memberships. In one embodiment, such offers are capable of being viewed by users who are not members currently of the loyalty program, but they may be provided an opportunity to join the loyalty program to be permitted to redeem the offer. When a user “checks in” to a particular venue location, offers associated with that venue are displayed to the user in the display of a mobile device (e.g., smart phone, cell phone, etc.). The user may then accept and/or redeem one or more offers at the venue. For instance, the user may select one or more offers within the display to be redeemed at the venue location. Such offers may be displayed to the user based on any number of criteria, including previous purchase history of the user, offers redeemed by people in the user's social network, rating information collected on a particular offer, or other criteria, either alone or in combination with other information or criteria.

In another embodiment, offers are made to credit card holders that have a credit card account with a particular company. According to one embodiment, an offer may be made to a credit card holder that can be applied to the credit card holder's statement removing the need for a merchant to be involved in the redemption and crediting of a discount. Because the merchant does not have to be involved in the processing of the offer, it becomes easier to roll out particular offers to various locations, and to create offers that are independent of particular merchants. In one embodiment, a location-based service may be used to assist in processing such offers and notifying users that these offers have been applied to their accounts.

According to one embodiment, the location-based service may provide a control, that, when activated by a user at a merchant location, will notify a credit card system that the user intends to accept and/or redeem a particular offer. When the credit card is swiped at the location and the transaction completed, the credit card system may send transaction details to the location-based service, and the location-based service may notify the user that the transaction was completed. Further, the notification may be displayed to the user and may indicate that the offer was accepted, and any savings that the user might receive on his/her credit card statement.

According to various embodiments of the present invention, a location-based service may present offers that can be accepted by a user in a variety of ways. For instance, the location-based service may display offers in a disabled state within a display of the mobile device until the user of the mobile device “checks in” to that particular venue location. When the user checks in, the system may permit the user to accept and/or redeem that particular offer. A credit card company or other provider may provide a number of offers correlated to particular venue locations. These venue locations may be “owned” and maintained within the location-based service by a merchant. When users “check in,” they may be permitted to accept offers correlated with the checked in venue location.

In another embodiment, a user may selectively allow the location-based service to send offers to the user's mobile device as the user changes his/her location. These offers may be targeted to particular graphical areas or regions. Venue owners may be permitted to associate, within a management interface of a location-based service, one or more offers to a particular region. If a user having a mobile device and location-based service program enters that region, an indication of an offer may be presented to the user. In this way, the likelihood of an offer being accepted is higher, as the indication is provided to the user while they are within the targeted region.

Further, particular offers may be targeted to particular users based on one or more criteria. For instance, certain users may be presented particular offers based on demographic information, information provided by the user, or other information, along or in combination with other information. In one example implementation, a user may be targeted for a particular offer based on an indication that the user would like to visit a particular venue location in the future (e.g., a “to do” list). For instance, if a particular user indicated that he/she wanted to visit a Starbucks location, an offer system may target the user to receive an offer at that particular entry in the user's “to-do” list.

To enable acceptance and/or redemption of particular offers, a location-based service may pass an indication (e.g., a message using a communication protocol) to a credit card system, the message including one or more data items. For instance, the indication may include an identifier of the venue (e.g., a unique venue identifier), a user identifier (e.g., a user id of the location-based service or credit card username), and/or an identifier of the offer that is to be accepted and/or redeemed. In one implementation, the offer identifier may be associated with a particular discount or the message may indicate what discount should be applied to the user's account. The credit card system may associate that offer identifier with a credit card account for the user (e.g., to apply a discount to his/her statement). In response to this offer being accepted, the credit card system may send an acknowledgement message to the location-based service indicating that the offer is associated with the credit card account of the user. The location-based service may in turn notify the user (e.g., via the mobile device), that the offer was accepted and applied to his/her account.

In another embodiment, a third party provider of offers may be capable of distributing such offers via the location-based service. For instance, a third party provider of coupons may indicate particular coupon offers that are available to the user based on their location (e.g., as determined by the location of a mobile device, such as a smartphone). The third party may associate certain offers with certain venue locations in the location-based service by creating the offer in the location-based service, determine venues to which the offer applies, and associate the offer with the venue location in the location-based service. Once created, the user may be capable of redeeming the offer when they are proximate to the venue location with which the offer is associated.

According to another embodiment it is appreciated that while some offers will need to be redeemed from the venue location, other types of offers can be redeemed from any location. In one implementation, the user is notified about the offer when the user is close to a particular location (e.g., the venue location). Such a notification may be presented to the user, for example, using an interface of a mobile device. For instance, an indicator in a display of the mobile device may show an offer to a user responsive to the user moving to a particular location (e.g., proximate to a particular venue location).

In one embodiment, the offer redemption may be completed on the mobile device, and the user may proceed to the venue to claim the product or service. In another embodiment, an interface may be provided on the mobile device or a merchant device located at the venue that receives information from the user required to accept the offer. In one embodiment, coupon offers may be printed at check-out at a venue location (e.g., as printed by a Catalina printer or other method) and may be redeemed during the current transaction (e.g., if there is a qualifying purchase).

In yet another embodiment, a merchant may be capable of providing one or more offers responsive to a user “checking in” to a particular location. In one embodiment, an association is made between a location-based service user identification and a loyalty program identity. Because an association is made using the user identification of the location-based service that tracks the user's location, actions performed using the location-based service at that location can be applied to the loyalty program account. Conversely, use of a loyalty program account at a venue location can be used to “check in” the user to that particular venue location (e.g., an action of a user “swiping” their loyalty program card at the venue location may be used to automatically “check in” the user within the location-based service.

In one embodiment, an interface may be provided on the mobile device that lists offers available nearby the location of the user. For instance, the offers may be shown as an ordered list within the interface based on distance. Such a display may be useful for notifying a user of an offer that he/she would likely accept based on his/her interests and the location of the user. Such a display may also include offers based on the interest(s) of other users within the social network of the user, recommendations by users in their network, and/or popularity of the offer (e.g., as determined by acceptances, rating in the social network, etc.). In one embodiment, users may opt in to receive offers that are available nearby the user's location. Such offers may be “pushed” to users as the user changes location. Location along with any other criteria may be used to determine whether a user may be presented with an offer.

According to another aspect, it is appreciated that a location-based service may assist with the management and redemption of offers for a number of third party services. For instance, a location-based service may be used to manage offers for credit card providers, wireless (e.g., Bluetooth) payment systems, “powered” cards such as dynamic credit cards that create unique codes to perform transactions, loyalty programs and cards, NFC sticker programs (e.g., that are placed on mobile phones to perform transactions), NFC-capable devices (e.g., a mobile phone, NFC card, etc.), rewards points programs, third party coupon providers, merchants, or any other provider or service. There may be certain programs that have different aspects of different types of programs (e.g., certain “powered” cards permit purchases to be applied to a credit card account or loyalty points may be used for conducting a transaction by activating a switch on the powered card).

Tools may be provided that associate offers with particular identities of a user in the location-based service, as well as identities of the user within the third party program (e.g., a credit card account, loyalty account, or other identity in any other program). Tools may also be provided to discern between different accounts to which the offer may apply (e.g., a credit card account vs. a loyalty account). As discussed above, there may be an interface tool presented on a display of a mobile device that permits an association of an offer with a particular program and/or identity of the user within that program. For instance, an interface control may be provided that when selected by the user, permits an offer to be associated with an account (e.g., a credit card or other type of account). In other implementations, offers may be associated dynamically based on the user's location as determined by the location-based service.

Yet other aspects of the present invention allow a location-based service to provide offers in real time to users based on users' locations. Such offers may be sourced from within the location-based service (e.g., provided by venue owners and defined on their venue objects), or may be sourced from locations outside of the location-based system. For instance, offers may be associated with venue locations via an API provided to companies that create offers such as merchants or companies that receive and process offers on behalf of providers (e.g., Groupon). In yet another implementation, the location-based service may be integrated with one or more offer providers, and the system may be adapted to pull offers into the location-based system and provide them to users.

Other embodiments of the present invention may relate to targeting offers to particular users based on one or more criteria. For instance, particular offers may be made and/or presented to the user of a mobile device based on the determined location of that particular device. Offers presented may also be determined based on whether a particular user “checked-in” to the venue associated with the offer previously and/or presently. Further, offers may be targeted to users based on their social network relation to other users. For instance, some people may “follow” other users, companies, or products on a social network such as the Twitter network, Facebook network or other network types, and based on that following, certain offers may be targeted responsive to that relation. In yet another implementation, users that are friends of other users that follow particular users, companies or products may also be targeted for offers based on that relation.

In another embodiment, the user may be presented an indication that identifies a justification for an offer presented to a user. For instance, a user may be shown an indication that identifies a social relation to another user (e.g., “Your friend Fred recommended this restaurant”) within the interface that displays the offer. Because there is a context being presented along with the offer, the user may be more likely to redeem particular offers based on the justification provided. According to one embodiment, a location-based service may present personal justifications for particular offers (e.g., “You have been to 7 related places”) that indicate a user's behavior that led to an offer being presented.

In another example, the location-based service may present to a user a social network related justification that depends on what the user's social network has done at a particular venue. For instance, a social justification may indicate “7 friends have been here” and a search may be performed of the user's network based on a particular venue to determine appropriate offers to be targeted to a particular user. Offers may also be targeted to users within a social network (e.g., a user and their immediate friends), whereby a notification may be sent targeting a particular offer to a group of users in a social network. Such targeting may be in response to one or more of the users having a social connection purchasing or otherwise accepting a particular offer.

Offers may be targeted based on social information or other information, either alone or in combination. For instance, offers may also be targeted to users based on the rate at which a particular offer is being accepted, loyalty metrics such as frequency of visit, recency of visit, spend amount (e.g., average, peak, volume, etc.), or other information relating to the user such as the behavior of the user, demographic information, among other types.

According to one aspect of the present invention, a method for processing an offer is provided. The method comprises acts of storing, in a distributed computer system of a location-based service, at least one offer; associating the at least one offer with a credit card program, determining a location of a mobile device associated with a user, determining that the determined location is proximate to a venue at which the at least one offer may be redeemed, presenting, to the user in a display of the mobile device associated with the user, an indication of the at least one offer responsive to the act of determining that the determined location is proximate to a venue at which the at least one offer may be redeemed, and permitting the user to redeem the offer at the venue. According to one embodiment of the present invention, the method further comprises an act of storing an indication in the distributed computer system of the location-based service, the indication identifying that the user is checked in to the venue. According to another embodiment of the invention, the act of presenting the indication of the at least one offer is responsive to an act of providing a control of the mobile device that, when activated, displays one or more offers that are capable of being redeemed at the location of the mobile device. According to another embodiment of the invention, the method further comprises an act of associating an identity of the user in the location-based service with an identity of the user in the credit card program. According to another embodiment of the invention, one or more offers are displayed only if the user is an authorized account holder in the credit card program.

According to one embodiment of the present invention, the method further comprises an act of permitting the user to select, within the display of the at least one offer, a control that associates the at least one offer with the identity of the user in the credit card program. According to another embodiment of the invention, the method further comprises an act of storing, by the distributed computer system of a location-based service, an indication of the association of the at least one offer associated with the identity of the user in the credit card program. According to another embodiment of the invention, the method further comprises an act of accepting, from the user at the venue, the identity of the user in the credit card program, retrieving the indication of the association of the at least one offer associated with the identity of the user in the credit card program, and applying the at least one offer to a transaction involving the user at the venue. According to another embodiment of the invention, the act of accepting, from the user at the venue, the identity of the user in the credit card program comprises an act of scanning a credit card at the venue.

According to one embodiment of the present invention, the method further comprises an act of sending, by a computer system associated with the venue to the distributed computer system of the location-based service, an indication that the at least one offer was redeemed at the venue. According to another embodiment of the invention, the method further comprises indicating, to the user in the display of the mobile device, the indication that the at least one offer was redeemed at the venue. According to another embodiment of the invention, the method further comprises applying, by a computer system operated by a credit card company, the at least one redeemed offer to a credit card associated with the user.

According to one aspect of the present invention, a method for processing an offer is provided. The method comprises acts of storing, in a distributed computer system of a location-based service, at least one offer; associating the at least one offer with a credit card program, determining a location of a mobile device associated with a user, determining that the determined location is proximate to a venue at which the at least one offer is available, presenting, to the user in a display of the mobile device associated with the user, an indication of the at least one offer responsive to the act of determining that the determined location is proximate to a venue at which the at least one offer is available, and permitting the user to accept the offer. According to one embodiment of the invention, the method further comprises an act of storing an indication in the distributed computer system of the location-based service, the indication identifying that the user is checked in to the venue. According to another embodiment of the invention, the act of presenting the indication of the at least one offer is responsive to an act of providing a control of the mobile device that, when activated, displays one or more offers that are capable of being accepted at the location of the mobile device. According to another embodiment of the invention, the method further comprises an act of associating an identity of the user in the location-based service with an identity of the user in the credit card program. According to another embodiment of the invention, one or more offers are displayed only if the user is an authorized account holder in the credit card program.

According to one embodiment of the present invention, the method further comprises an act of permitting the user to select, within the display of the at least one offer, a control that associates the at least one offer with the identity of the user in the credit card program. According to another embodiment of the invention, the method further comprises an act of storing, by the distributed computer system of a location-based service, an indication of the association of the at least one offer associated with the identity of the user in the credit card program. According to another embodiment of the invention, the method further comprises an act of accepting, from the user at the venue, the identity of the user in the credit card program, retrieving the indication of the association of the at least one offer associated with the identity of the user in the credit card program, and applying the at least one offer to a transaction involving the user at the venue. According to another embodiment of the invention, the act of accepting, from the user at the venue, the identity of the user in the credit card program comprises an act of scanning a credit card at the venue.

According to one embodiment of the present invention, the method further comprises an act of sending, by a computer system associated with the venue to the distributed computer system of the location-based service, an indication that the at least one offer was accepted. According to another embodiment of the invention, the method further comprises indicating, to the user in the display of the mobile device, the indication that the at least one offer was accepted. According to another embodiment of the invention, the method further comprises applying, by a computer system operated by a credit card company, the at least one accepted offer to a credit card associated with the user. According to another embodiment of the invention, the method further comprises an act of permitting the user to accept the at least one offer using the mobile device. According to another embodiment of the invention, the method further comprises an act of permitting the user to accept the at least one offer at the venue. According to another embodiment of the invention, the method further comprises an act of indicating to the user in the display of the mobile device an acceptance of the at least one offer.

According to one embodiment of the present intention, the method further comprises an act of permitting the user to fulfill the acceptance of the at least one offer at the venue responsive to the display of the acceptance of the at least one offer. According to another embodiment of the invention, the method further comprises acts of displaying information relating to the acceptance of the at least one offer and using, at the venue, the displayed information to fulfill the acceptance of the at least one offer. According to another embodiment of the invention, the method further comprises an act of permitting the user to execute a purchase associated with the at least one offer using the mobile device.

According to one aspect of the present invention, a system for processing an offer is provided. The system comprises a location-based service including a distributed computer system having at least one processor and a memory, a component for storing, in the memory, at least one offer, a component for storing, in the memory, an association of the at least one offer with a credit card program, a component for determining a location of a mobile device associated with a user, a component that determines that the determined location is proximate to a venue at which the at least one offer may be accepted, a display component configured to present, to the user in a display of the mobile device associated with the user, an indication of the at least one offer responsive to determining that the determined location is proximate to a venue at which the at least one offer may be accepted, and a component that permits the user to accepted the offer. According to one embodiment of the present invention, the system further comprises a component configured to store an indication in the memory of the distributed computer system of the location-based service, the indication identifying that the user is checked in to the venue. According to another embodiment of the invention, the display component configured to present the indication of the as least one offer is responsive to a control of the mobile service that, when activated, displays one or more offers that are capable of being accepted at the location of the mobile device.

According to one embodiment of the present invention, the system further comprises a component configured to associate an identity of the user in the location-based service with an identity of the user in the credit card program. According to another embodiment of the invention, one or more offers are displayed only if the user is an authorized account holder in the credit card program. According to another embodiment of the invention, the system further comprises a component that permits the user to select, within the display of the at least one offer, a control that associates the at least one offer with the identity of the user in the credit card program. According to another embodiment of the invention, the system further comprises a component for storing, in the memory of the distributed computer system of the location-based service, an indication of the at least one offer associated with the identity of the user in the credit card program. According to another embodiment of the invention, the system further comprises a component configured to accept, from the user at the venue, the identity of the user in the credit card program, a component configured to retrieve the indication of the association of the at least one offer associated with the identity of the user in the credit card program, and a component configured to apply the at least one offer to a transaction involving the user at venues.

According to one embodiment of the present invention, the component configured to accept the identity of the user in the credit card program comprises a scanner configured to scan a credit card at the venue. According to another embodiment of the invention, the system further comprises a component of a computer system associated with the venue, the component being configured to send to the distributed computer system of the location-based service, an indication that the at least one offer was accepted. According to another embodiment of the invention, the system further comprises a component adapted to indicate, to the user in the display of the mobile device, the indication that the at least one offer was accepted. According to another embodiment of the invention, the system further comprises a component adapted to apply the as least one accepted offer to a credit card account associated with the user.

According to one aspect of the present invention, a method for processing an offer is provided. The method comprises acts of storing, in a distributed computer system of a location-based service, at least one offer, storing, in the distributed computer system, an association of the at least one offer with a loyalty program, determining a location of a mobile device associated with a user, determining that the determined location is proximate to a venue at which the at least one offer may be accepted, presenting, to the user in a display of the mobile device associated with the user, an indication of the at least one offer responsive to the act of determining that the determined location is proximate to a venue at which the at least one offer may be accepted, and permitting the user to accept the offer. According to one embodiment of the present invention, the method further an act of storing an indication in the distributed computer system of the location-based service, the indication identifying that the user is checked in to the venue. According to another embodiment of the present invention, the act of presenting the indication of the at least one offer is responsive to an act of providing a control of the mobile device that, when activated, displays one or more offers that are capable of being accepted at the location of the mobile device. According to another embodiment of the present invention, the method further comprises an act of associating an identity of the user in the location-based service with an identity of the user in the loyalty program.

According to one embodiment of the present invention, the method further comprises an act of permitting the user to select, within the display of the at least one offer, a control that associates the at least one offer with the identity of the user in the loyalty program. According to another embodiment of the invention, the method further comprises an act of storing, by the distributed computer system of a location-based service, an indication of the association of the at least one offer associated with the identity of the user in the loyalty program. According to another embodiment of the invention, the method further comprises an act of accepting, from the user at the venue, the identity of the user in the loyalty program, retrieving the indication of the association of the at least one offer associated with the identity of the user in the loyalty program, and applying the at least one offer to a transaction involving the user at the venue. According to another embodiment of the invention, the act of accepting, from the user at the venue, the identity of the user in the loyalty program comprises an act of scanning a loyalty program card at the venue.

According to one embodiment of the present invention, the method further comprises an act of sending, by a computer system associated with the venue to the distributed computer system of the location-based service, an indication that the at least one offer was accepted at the venue. According to another embodiment of the invention, the method further comprises indicating, to the user in the display of the mobile device, the indication that the at least one offer was accepted at the venue.

According to one aspect of the present invention, a system for processing an offer is provided. The system comprises a location-based service including a distributed computer system having at least one processor and a memory, a component for storing, in the memory, at least one offer, a component for storing, in the memory, an association of the at least one offer with a loyalty program, a component for determining a location of a mobile device associated with a user, a component that determines that the determined location is proximate to a venue at which the at least one offer may be accepted, a display component configured to present, to the user in a display of the mobile device associated with the user, an indication of the at least one offer responsive to determining that the determined location is proximate to a venue at which the at least one offer may be accepted, and a component that permits the user to accept the offer. According to one embodiment of the present invention, the system further comprises a component configured to store an indication in the distributed computer system of the location-based service, the indication identifying that the user is checked in to the venue. According to another embodiment of the invention, the display component configured to present the indication of the at least one offer is responsive to a control of the mobile device that, when activated, displays one or more offers that are capable of being redeemed at the location of the mobile device. According to another embodiment of the invention, the system further comprises a component configured to associate an identity of the user in the location-based service with an identity of the user in the loyalty program.

According to one embodiment of the present invention, the system further comprises a component configured to permit the user to select, within the display of the at least one offer, a control that associates the at least one offer with the identity of the user in the loyalty program. According to one embodiment of the present invention, the system further comprises a component configured to store, by the distributed computer system of a location-based service, an indication of the association of the at least one offer associated with the identity of the user in the loyalty program. According to another embodiment of the invention, the system further comprises a component configured to accept, from the user at the venue, the identity of the user in the loyalty program, a component to retrieve the indication of the association of the at least one offer associated with the identity of the user in the loyalty program, and a component configured to apply the at least one offer to a transaction involving the user at the venue. According to another embodiment of the present invention, the component configured to accept, from the user at the venue, the identity of the user in the loyalty program comprises a scanner configured to scan a loyalty program card at the venue. According to another embodiment of the present invention, the system further comprises a component configured to send, from a computer system associated with the venue to the distributed computer system of the location-based service, an indication that the at least one offer was accepted at the venue. According to another embodiment of the present invention, the system further comprises a component configured to indicate, to the user in the display of the mobile device, the indication that the at least one offer was accepted at the venue.

According to one aspect of the present invention, a method for processing an offer is provided. The method comprises acts of determining, in a distributed computer system of a location-based service, a location-based service identity of a user, defining, in a computer system of a loyalty program, a loyalty program identity associated with the a loyalty program account, associating, within the distributed computer system of a location-based service, the location-based service identity of the user with the loyalty program identity, determining a location of a mobile device associated with the user, and performing an action relating to the loyalty program identity associated with the a loyalty program account responsive to the determined location. According to one embodiment of the present invention, the method further comprises an act of storing, in the distributed computer system of a location-based service, at least one offer associated with a loyalty program. According to another embodiment of the invention, the method further comprises an act of determining that the determined location is proximate to a venue at which the at least one offer may be accepted. According to another embodiment of the invention, the method further comprises an act of presenting, to the user in a display of the mobile device associated with the user, an indication of the at least one offer responsive to the act of determining that the determined location is proximate to a venue at which the at least one offer may be accepted. According to another embodiment of the invention, the method further comprises an act of permitting the user to redeem the offer at the venue.

According to one embodiment of the present invention, the method further comprises an act of storing an indication in the distributed computer system of the location-based service, the indication identifying that the user is checked in to the venue. According to another embodiment of the invention, the act of presenting the indication of the at least one offer is responsive to an act of providing a control of the mobile device that, when activated, displays one or more offers that are capable of being accepted at the location of the mobile device. According to another embodiment of the invention, one or more offers are displayed only if the user is an authorized account holder in the loyalty program. According to another embodiment of the invention, the method further comprises an act of receiving loyalty program identification information at the venue, and responsive to receiving the loyalty program identification information, providing the at least one offer associated with a loyalty program to the user. According to another embodiment of the invention, the method further comprises an act of providing an indication of the at least one offer to the user proximate to a location of the venue. According to another embodiment of the invention, the method further comprises an act of printing, at the venue location, a coupon identifying the at least one offer during a checkout of the user.

According to one embodiment of the present invention, the method further comprises an act of indicating, to the user in a display of the mobile device, the at least one offer. According to another embodiment of the invention, the method further comprises an act of storing, by the distributed computer system of a location-based service, an indication of the association of the location-based service identity of the user with the loyalty program identity. According to another embodiment of the invention, the act of accepting act of receiving loyalty program identification information at the venue comprises an act of swiping a loyalty program card at the venue. According to another embodiment of the invention, the act of accepting act of receiving loyalty program identification information at the venue comprises an act of receiving, from the user, loyalty program account information at the venue. According to another embodiment of the invention, the method further comprises an act of sending, by a computer system associated with the venue to the distributed computer system of the location-based service, an indication that the at least one offer was redeemed at the venue. According to another embodiment of the invention, the method further comprises indicating, to the user in the display of the mobile device, the indication that the at least one offer was redeemed at the venue.

According to one aspect of the present invention, a method for processing an offer is provided. The method comprises acts of receiving, in a distributed computer system of a location-based service, a location of a mobile device associated with the user, determining a location-based service identity of the user, defining, in the distributed computer system of a location-based service, a plurality of offers that may be accepted by users of the location-based service, and responsive to the received location and parameters associated with the location-based service identity of the user, targeting at least one of the plurality of offers to the user. According to one embodiment of the present invention, the act of targeting is responsive to an act of determining a social relation of the user to one or more other users in a social network. According to another embodiment of the present invention, the act of targeting is responsive to an act of determining an interest of the one or more other users in the social network. According to another embodiment of the present invention, the act of targeting is responsive to an act of determining a rating of the at least one offer by the one or more other users in the social network. According to another embodiment of the present invention, the act of targeting is responsive to an act of determining a popularity of the at least one offer. According to another embodiment of the present invention, the act of targeting is responsive to the user activating a selection indicating that the user desires to receive targeted offers. According to another embodiment of the present invention, at least one of the plurality of offers is received from a third party offer service. According to another embodiment of the present invention, at least one of the plurality of offers is defined by a venue operator within a management interface of the location-based service.

According to one embodiment of the present invention, at least one of the plurality of offers is received from an external system via an API of the location-based service. According to another embodiment of the present invention, the method further comprises acts of determining a ranking of the plurality of offers and displaying, in the interface of the mobile device, the determined ranking of the plurality of offers. According to another embodiment of the present invention, the act of determining a ranking is responsive to an act of determining a relation of the user to one or more other entities defined within a social network. According to another embodiment of the present invention, the act of determining a ranking of the plurality of offers is responsive to an act of determining an action or relation of the one or more other entities within the social network to at least one of the plurality of offers. According to another embodiment of the present invention, the act of determining a ranking is responsive to an act of determining one or more parameters relating to the user. According to another embodiment of the present invention, the one or more parameters includes at least one of a group comprising loyalty metrics relating to the user, behavioral information of the user, purchasing behavior of the user, offer acceptance information relating to the user, and demographic information relating to the user.

According to one embodiment of the present invention, the ranking is determined, at least in part, based on a location of the mobile device associated with the user and respective locations of venues associated with the plurality of offers. According to another embodiment of the present invention, the method further comprises an act of determining that the determined location of the mobile device is proximate to a venue at which at least one of the plurality of offers may be accepted.

According to one aspect of the present invention, a method for processing an offer is provided. The method comprises acts of receiving, by a distributed computer system of a location-based service, at least one offer, determining a location of a mobile device associated with a user, determining that the determined location is proximate to a venue at which the at least one offer is available, presenting, to the user in a display of the mobile device associated with the user, an indication of the at least one offer responsive to the act of determining that the determined location is proximate to a venue at which the at least one offer is available, and permitting the user to accept the offer. According to another embodiment of the present invention, the method further comprises an act of storing, in a memory of the distributed computer system of the location-based service, the at least one offer. According to another embodiment of the invention, the method further comprises an act of associating the at least one offer with at least one of a group comprising a credit card program, a loyalty program, and a third party offeror. According to another embodiment of the invention, the method further comprises an act of targeting the at least one offer to the user responsive to the determined location. According to another embodiment of the invention, the act of targeting the at least one offer to the user is further responsive to the one or more parameters associated with the user. According to another embodiment of the invention, the one or more parameters comprise at least one user parameter relating to at least one of the group comprising demographic information of the user, behavioral information of the user, and psychographic information of the user. According to another embodiment of the invention, the act of receiving the at least one offer includes an act of receiving the at least one offer from a source of offers separate from the location-based service.

According to one embodiment of the present invention, the method further comprises an act of presenting, in the display of the mobile device, a control that, when selected by the user, permits the user to accept the at least one offer. According to another embodiment of the invention, the act of permitting the user to accept the offer further comprises an act of automatically accepting the offer without user intervention. According to another embodiment of the invention, the act of determining that the determined location is proximate to the venue at which at which the at least one offer may be fulfilled by the user. According to another embodiment of the invention, the method further comprises an act of permitting the user to accept the at least one offer using the mobile device. According to another embodiment of the present invention, the method further comprises an act of permitting the user to accept the at least one offer at the venue. According to another embodiment of the present invention, the method further comprises an act of indicating to the user in the display of the mobile device an acceptance of the at least one offer. According to another embodiment of the invention, the method further comprises an act of permitting the user to fulfill the acceptance of the at least one offer at the venue responsive to the display of the acceptance of the at least one offer.

According to one embodiment of the present invention, the method further comprises acts of displaying information relating to the acceptance of the at least one offer and using, at the venue, the displayed information to fulfill the acceptance of the at least one offer. According to another embodiment of the invention, the method further comprises an act of permitting the user to execute a purchase associated with the at least one offer using the mobile device.

According to one aspect of the present invention, a system for processing an offer is provided. The system comprises a location-based service including a distributed computer system having at least one processor and a memory, a component adapted to receive, by the distributed computer system of the location-based service, at least one offer, a component adapted to determine a location of a mobile device associated with a user, a component adapted to determine that the determined location is proximate to a venue at which the at least one offer may be accepted, a component adapted to present, to the user in a display of the mobile device associated with the user, an indication of the at least one offer responsive to the act of determining that the determined location is proximate to a venue at which the at least one offer may be accepted, and a component adapted to permit the user to accept the offer. According to one embodiment of the present invention, the system further comprises a component adapted to store, in a memory of the distributed computer system of the location-based service, the at least one offer. According to another embodiment of the invention, the system further comprises a component adapted to associate the at least one offer with at least one of a group comprising a credit card program, a loyalty program, and a third party offeror. According to another embodiment of the invention, the system further comprises a component adapted to target the at least one offer to the user responsive to the determined location. According to another embodiment of the invention, the component adapted to target the at least 103 one offer to the user is further responsive to the one or more parameters associated with the user. According to another embodiment of the invention, the one or more parameters comprise at least one user parameter relating to at least one of the group comprising demographic information of the user, behavioral information of the user, and psychographic information of the user.

According to one embodiment of the present invention, the component adapted to receive the at least one offer is further adapted to receive the at least one offer from a source of offers separate from the location-based service. According to one embodiment of the present invention, the system further comprises a component adapted to present, in the display of the mobile device, a control that, when selected by the user, permits the user to accept the at least one offer. According to another embodiment of the invention, the component that is adapted to permit the user to redeem the offer at the venue further comprises a component that automatically accepts the offer at the venue without user intervention.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 shows a block diagram of a distributed system suitable for performing various aspects of the present invention;

FIG. 3 shows a process for crediting an accepted offer to a credit card account according to one embodiment of the present invention;

FIG. 4 shows a process for locating available offers and redeeming offers at a particular venue location according to one embodiment of the present invention;

FIG. 5 shows a process for communicating between a location-based service and a credit card system for processing offers according to one embodiment of the present invention;

FIG. 6 shows a process for interacting between a location-based system and a loyalty program system according to one embodiment of the present invention;

FIG. 7 shows a process for interacting between a location-based service and a loyalty program according to one embodiment of the present invention;

FIG. 8 shows a process for interacting between a credit card system and a location-based service according to one embodiment of the present invention;

FIG. 9 shows a process for interacting between a credit card system and a location-based service according to one embodiment of the present invention;

FIG. 10 is a block diagram showing a process for authenticating to a service that uses location-based service resources;

FIG. 11 is a block diagram showing a process for processing and redeeming offers using a location-based service according to one embodiment of the present invention;

FIG. 12 is a block diagram showing a process for verifying redeemed offers using a location-based service according to one embodiment of the present invention;

FIG. 13 is a block diagram showing a process for redeeming offers using a location-based service according to one embodiment of the present invention;

FIG. 14 is a block diagram showing a process for redeeming credit card offers using a location-based service according to one embodiment of the present invention;

FIG. 15 shows a process for authorizing access by a location-based service to a credit card account according to one embodiment of the present invention;

FIG. 16 shows a process for processing purchases of third-party offers using a location-based service according to one embodiment of the present invention;

FIG. 17 shows a process for presenting offers to users in accordance with one embodiment of the present invention;

FIG. 18 shows a process targeting offers to users according to one embodiment of the present invention;

FIG. 19 shows a process that permits a user to control whether or not the user receives offers from a location-based system according to one embodiment of the present invention;

FIG. 20 shows an example computer system with which various aspects of the invention may be practiced;

FIG. 21 shows an example storage system capable of implementing various aspects of the present invention;

FIG. 22 shows one example implementation of a process where the offers may be purchased in redeemed using a mobile device according to one embodiment of the present invention;

FIG. 23 shows an example interface of a mobile device according to one embodiment of the present invention;

FIG. 24 shows another example interface of a mobile device according to one embodiment of the present invention;

FIG. 25 shows a process for redeeming offers associated with a credit card account in processing such offers using a location-based system according to one embodiment of the present invention;

FIG. 26 shows an example interface of the a mobile device that displays an indication to the user according to one embodiment of the present invention;

FIGS. 27A-27B show an example of a loyalty program integrated with a location-based service according to one embodiment of the present invention;

FIG. 28 shows an example website interface 2800 for use with a loyalty program in accordance with one embodiment of the present invention; and

FIG. 29 shows another example website interface for use with a loyalty program in accordance with one embodiment of the present invention.

### DETAILED DESCRIPTION

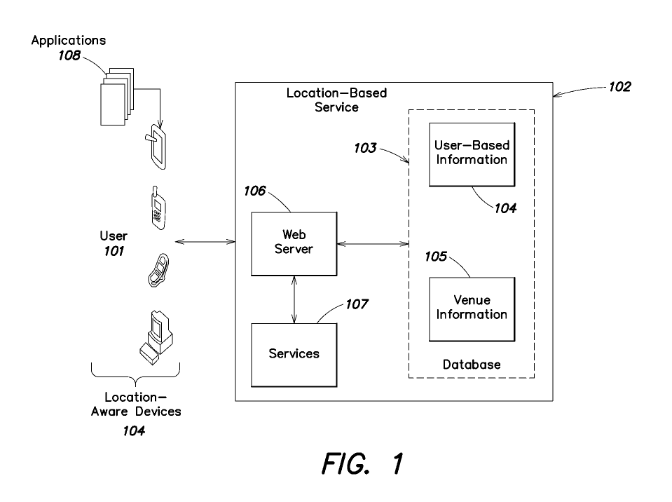

FIG. 1 shows a block diagram of a location-based service and system suitable for incorporating various aspects of the present invention. For instance, a location-based service 102 may permit one or more users (e.g., user 101) to interact with one or more other users, systems and services based on their location. To this end, the user's location may be determined using one or more location-aware devices (e.g., devices 104), such as, for example, a cell phone, smart phone, PDA, tablet computer, laptop or other system. Users may use other methods for interacting with the system to receive and redeem offers, such as by using a “powered” card as discussed above, an NFC terminal (e.g., an NFC sticker placed on the back of a mobile phone), a loyalty club card, a credit card or other methods.

In one embodiment, service 102 may include one or more components. Such components may be implemented using one or more computer systems. In one embodiment, location-based service 102 may be implemented on a distributed computer system using one or more communication networks (e.g., the Internet). In one implementation, the service is implemented in a cloud-based computing platform, such as the well-known EC2 platform available commercially from Amazon.com, Seattle, Wash. In another example, a distributed application may be provided using servers and client systems provided by an application provider. Other implementations are possible and are within the scope and spirit of the invention, and it is appreciated that other platforms in any combination may be used.

Service 102 may include a web server 106 which is capable of serving as a front end to the location-based service 102. Devices may communicate and display data provided by server 106 to the user (e.g., user 101). Notably, devices may include controls that perform various functions in a location-based application (such as one or more of application(s) 108), such as viewing venues proximate to the user's location, reviewing information regarding proximate venues left by other users, communicating with other users, among other functions. Further, such devices may provide the location of the user to the location-based service 102, and this location information may be used to perform one or more functions.

Service 102 may also provide one or more related services (e.g., services 107), such as a service for recommending venues, storing pictures based on location, location-based games, or other service that utilizes location information relating to its users. Services 107 may be integral to location-based service 102 or many alternatively operate in conjunction with location-based service 102, (e.g., by communicating with the location-based service through an Application Programming Interface (API)). Notably, according to one aspect of the present invention, credit card companies, merchant, and third party offerors may create offers associated with particular venue locations defined within service 102.

Service 102 may also be capable of storing information in one or more databases (e.g., database 103). For instance, service 102 may be configured to store user-based information (e.g., user-based information 104) such as a user identification, identifications of friends associated with the user identification, any history information such as locations visited, preference information for particular venue locations, notes regarding venue locations visited, among other user-related information. Service 102 may also be capable of storing venue information (e.g., venue information 105) that may include, for example, location information (e.g., address, latitude, longitude, altitude, etc.), contact information, venue description, among other information. Venue information may also include, according to one embodiment, offers associated with a particular venue location.

One commercially-available system that may be suitable for implementing various aspects of the present invention may include the Foursquare service, available at http://www.foursquare.com and provided by Foursquare Labs, Inc., New York. Other systems capable of providing location-based services are available and are capable of implementing various aspects of the present invention.

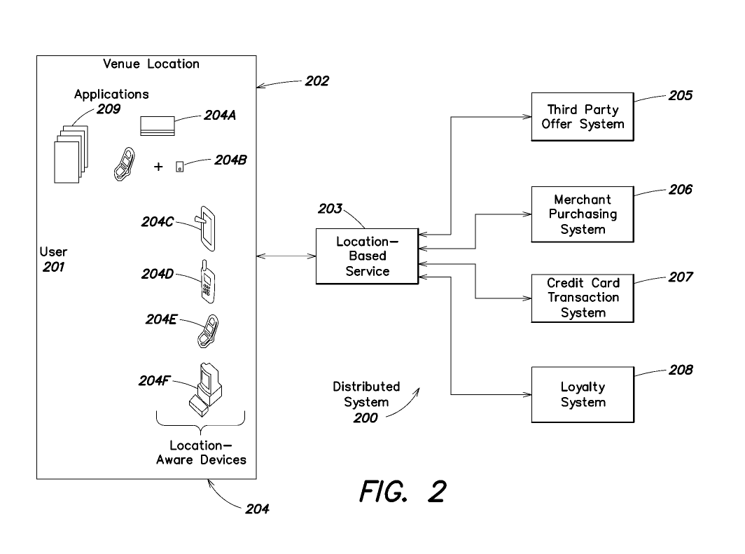

FIG. 2 shows a system incorporating various aspects of the present invention. In particular, a distributed computer system (e.g., system 200) may be provided that is capable of providing offers in association with a location-based system (e.g., system 203). Such offers may be defined and managed among one or more systems that work integrally with location-based service 203. For instance, a third party offer system (e.g., system 205) may be capable of defining and managing offers for one or more venue locations. The third party offer system may be capable of defining offers that extend across different venues, merchants, and locations. One example of an offer management system includes the well-known Groupon system (available on the Internet at http://www.groupon.com) used for managing coupon offers for various products and venue locations.

Such offers may be presented to users (e.g., user 201) at one or more venue locations (e.g., venue location 202) on one or more location-aware devices (e.g., device 204). For instance, offers may be presented, viewed, accepted, purchased, and/or redeemed using one or more applications 209 that execute on a location-aware device.

Device 204 may be any device, system, or item that can be used to locate a user. For instance, a user may use a “powered” credit card 204A to redeem an offer at the venue location or any other location. In another implementation, a user may use a device, system, or item as a payment method. For instance, a user may use an NFC terminal as is known in the art, such as one created by providing an NFC reader in a phone, affixing NFC sticker to non-NFC devices or otherwise providing a payment capability to a mobile phone (e.g., element 204B). Other systems may be used such as a tablet computer (element 204C), smartphone (element 204D), cell phone (204E), personal computer (element 204F), or other system type, either with or without payment capabilities.

Offers may be “free” offers in that they are received without a qualifying purchase. However, some offers may require a purchase, which may be performed online or at the venue location. In the case of an online purchased offer, a voucher or other indication of purchase may be provided to a user (e.g., electronically) to permit the user to fulfill the purchased offer at the venue location or any other location. In one embodiment, the voucher may be presented to the user in the form of an identifier or other information displayed on the mobile device that permits the user to purchase and/or redeem the offer at the venue location (e.g., a bar code, transaction number, offer number or other identification information). Some redemption of offers may be seamless, and require no intermediate step. For instance, the offer may be applied directly during a transaction performed at the venue location.

According to another embodiment, location-based service may be integrated with a merchant purchasing system (e.g., system 206). For instance, a merchant purchasing system may be capable of performing checkout functions at the venue location, such as scanning or otherwise inputting items to be purchased, and accepting payment from a consumer. According to one aspect, the merchant purchasing system may be capable of determining whether offers created in a location-based system apply to a particular transaction. For instance, merchants may define one or more offers using an interface of the location-based service (e.g., through a management interface or an API that attaches an offer to a particular venue location). When the location-based service determines that the user is located in a venue in which the offer may be redeemed, the merchant purchasing system may be notified that a particular offer applies. Certain offers may be redeemed by the merchant within the same transaction, and/or an offer may be provided that may be redeemed by the user in a future transaction (e.g., in the form of a coupon printed at the vendor location). Offers may be accepted and applied in real time at the vendor location (e.g., as a discount applied to the current transaction). In other embodiments, offers may include purchases that may be performed at locations other than the venue location. Further, such offers need not require a swipe of a credit card but can include any method of payment using any number of systems.

According to another embodiment, location-based service may be integrated with a credit card transaction system (e.g., system 207). In one example, the credit card transaction system may be capable of determining whether an offer applies to a transaction performed by a user using a location-based service. Further, in another embodiment, the credit card transaction system may be configured to apply an accepted offer to a user's statement without any interaction by the venue location. Alternatively, the redemption of the offer may be applied to the current transaction, without the need to wait for a credit to be applied to the user's statement. Some implementations may involve systems that perform the transaction at the venue location to apply the offer credit in real-time.

According to another embodiment, location-based service may be integrated with a loyalty system (e.g., system 208). In one embodiment, particular offers may be created and extended to loyalty card members based on their location (e.g., as determined by a location-based service). According to one embodiment, a user may be presented offers available to loyalty program members when the user “checks in” to a particular venue location and/or is displayed certain offers when the user is located in proximity to the location. In one implementation, an association may be maintained and stored by a distributed computer system that associates an identity of the user in the location-based service with an identity of the user in the loyalty program. Responsive to the user being located proximate the venue location, the user may be displayed (e.g., in the display of a mobile device) certain offers available to the user by virtue of being a loyalty card program member.

In one embodiment, the location-based service may accept a fee from an offer provider for the opportunity to promote offers using the location-based service. Offers may be paid for by the offer provider in any manner or on any basis, including impressions of an offer, redemption of an offer, display of an offer in an ordered search, among other bases for payment.

In another embodiment, a user is displayed certain offers that are available, and a control presented within the interface of the mobile device, when selected by the user, permits selected offers to be associated with the user (e.g., a credit card account, loyalty card account, or other account and/or identity).

In one embodiment, the user “checks in” using an application executing on the mobile device, and responsive to the user “checking in,” that user is notified of one or more offers that can be accepted and/or redeemed. Such offers may be accepted and/or redeemed proximate a location of the venue where the user “checked in.” In certain embodiments, the user may be permitted to check in using a number of different applications (e.g., CheckIn4Me, 4squareSMS, Foursquare, etc.) into the same location-based service or from another location-based service that shares location and check-in information regarding users. In one implementation, application providers may be permitted to receive offers from the location-based service for display to their users. Also, the location-based service may track the acceptance and/or redemption of offers through such applications, and provide application providers with a portion of the revenue realized by the transaction to which the offer is applied.

In yet another implementation, authentication to distributed resources in distributed system 200 may be provided using an authorization server (not shown) that permits access to distributed resources without sharing authorization information among services. Rather, authentication is performed directly with the authorization system which issues access tokens that are used to access particular information.

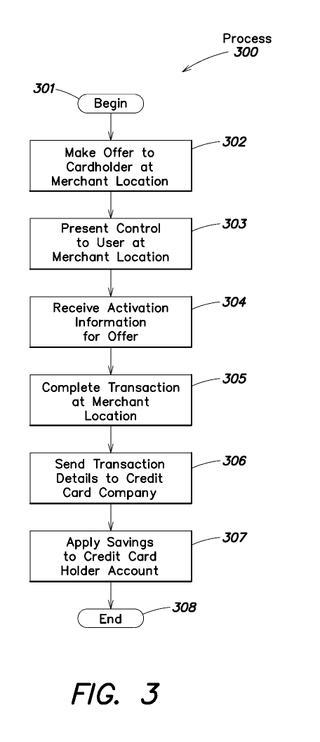

FIG. 3 shows a process 300 for crediting an accepted offer to a credit card account according to one embodiment of the present invention. At block 301, process 300 begins. At block 302, the location-based system makes an offer to a cardholder at a merchant location. For instance, as discussed above, this may be done within an interface of a mobile device. At block 303, the mobile device may be configured to present a control within the interface to a user at the merchant location. This control, when selected, may activate a particular offer that was displayed to the user.

At block 304, the mobile device receives an activation of the control by the user including activation information relating to the particular offer that was accepted. At block 305, a transaction is completed at the merchant location using the credit card associated with a particular credit card holder account. For instance, the credit card may be swiped or manually entered into a credit card processing device provided at the merchant location. In an alternative embodiment, the user may accept and/or redeem the offer outside of the venue location, either with or without providing the credit card information. At block 306, information relating to the transaction is sent to the credit card company. Such information may identify details of the transaction performed by the user at the merchant location.

According to one embodiment, a method is provided for associating particular offers with credit card accounts and having those offers be automatically associated with credit card holder accounts when used at the merchant location. For instance, at block 307, any savings applied to a particular offer may be automatically applied to a credit card holder account. For instance, an association may be made between a particular offer and a credit card holder account, and afterwards when the user performs a transaction that relates to the particular offer, a credit card system applies that offer to the cardholder's statement. One advantage of such a system may include, in one embodiment, that the user may be able to redeem offers in real-time at merchant locations by using only their credit cards, and thus the offer may be applied automatically to the user's account. At block 308, process 300 ends.

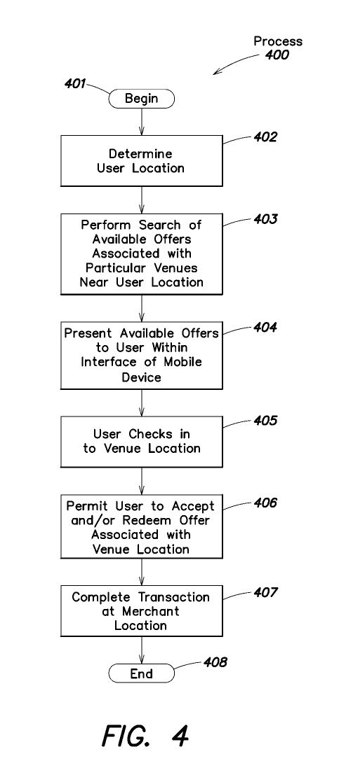

FIG. 4 shows a process for locating available offers and redeem offers at a particular venue location according to one embodiment of the present invention. At block 401, process 400 begins. At block 402, a location-based system determines the user location. This may be accomplished, for example, by a mobile device having GPS capability or other method of locating the location of the device. At block 403, the location-based system performs a search of available offers associated with particular venues near the user's location. For instance, there may be a number of offers associated with venue locations within the particular distance of the determined mobile device, within a defined area entered by the user, or other location parameter.

At block 404, the mobile device presents (e.g., in a display) available offers to the user within a list or other display construct. At block 405, the user “checks in” to a particular venue location. According to one embodiment, a user may be required to check-in prior to regaining any offers at that particular venue. At block 406, the location-based system permits a user to accept and/or redeem a selected offer associated with the venue location. At block 407, a merchant system completely transaction at the merchant location associated with the defined venue. At block 408, process 400 ends.

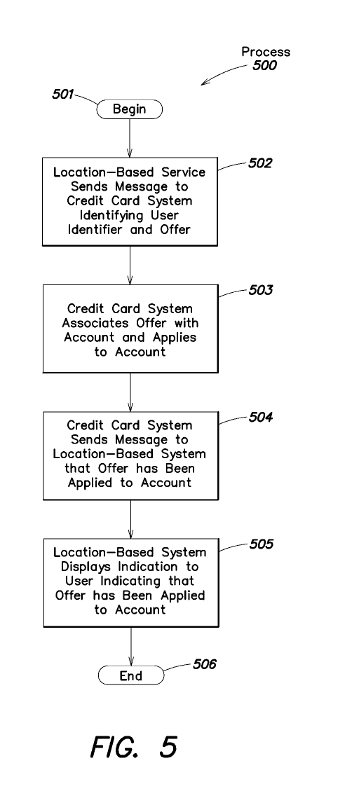

FIG. 5 shows a process for communicating between a location-based service and a credit card system for processing offers according to one embodiment of the present invention. At block 501, process 500 begins. At block 502, a location-based service sends a message to a credit card system that processes transactions, the message identifying a particular user identifier and an offer. At block 503, the credit card system associates the particular offer with an account of the user and applies the offer to the account. At block 504, the credit card system sends a message to a location-based system indicating that the offer has been (or will be) applied to the user's credit card account. Notably, an offer that is accepted using the credit card is performed at any location using the location-based service, and notification of the accepted offer associated with the credit card account is indicated to the user in real-time using the mobile device and location-based service. At block 505, the location-based system displays an indication to the user indicating that the offer has been applied to the credit card account. At block 506, process 500 ends.

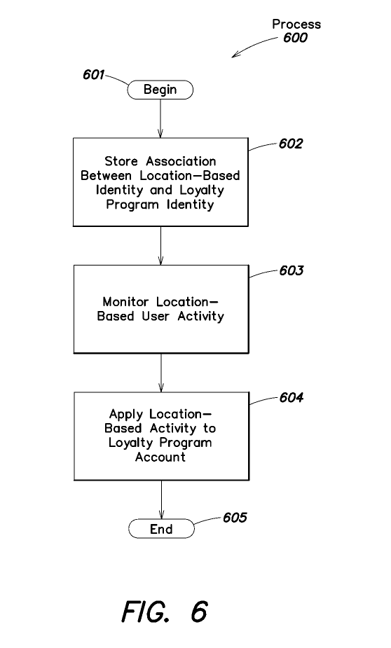

FIG. 6 shows a process for interacting between a location-based system and a loyalty program system according to one embodiment of the present invention. At block 601, process 600 begins. At block 602, a location-based system stores an association between a location-based identity and a loyalty program identity. For instance, the location-based identity may include a username within the location-based system. The loyalty program identity may include, for example, a loyalty program account that identifies a particular member. At block 603, the location-based system monitors location-based user activity. For instance, the user may change their location within the location-based system, the user may view and/or accept offers within an interface of a mobile device, or perform other actions within the location-based system. At block 604 responsive to that location-based activity, an action may be applied to a loyalty program account. For instance, the user may receive loyalty points, may receive special offers, offers may be applied to transactions, or the loyalty system may perform other functions relating to the loyalty account of the user. At block 605, process 600 ends.

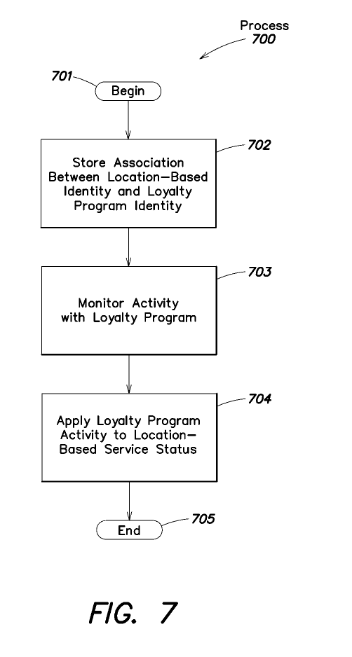

FIG. 7 shows a process for interacting between a location-based service and a loyalty program according to one embodiment of the present invention. At block 701, process 700 begins. At block 702, a loyalty program system stores an association between a location-based identity and loyalty program identity. As discussed above, a location-based identity may include the username identified within the location-based system. A loyalty program identity may include a member number or other identifier that identifies a user within a loyalty system. At block 703, the loyalty system monitors activity within the loyalty program. For instance, a user may “swipe” their loyalty card at a store, the user may login to an online loyalty program, or perform any other action involving the loyalty system. At block 704, the loyalty system applies the loyalty program activity to a location-based service status. For instance, the user may receive, be permitted to view and/or accept special offers from the loyalty program (e.g., while the user is physically located at a store associated with the loyalty program) from the location-based service, may be permitted to associate offers accepted in the location-based service with a membership in the loyalty program, or perform other actions. At block 705, process 700 ends.

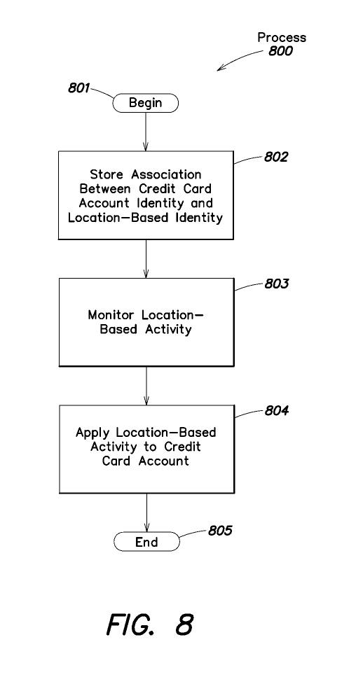

FIG. 8 shows process for interacting between a credit card system and a location-based service according to one embodiment of the present invention. At block 801, process 800 begins. At block 802, a location-based system stores an association between a credit card account identity and a location-based identity. As discussed above, the location-based identity may include a username defined within a location-based service. A credit card account identity may include, for example, a credit card account number, user name of a website associated with the credit card account, and/or any other information used to identify a credit card account. At block 803, the location-based service monitors location-based activity of the user. For instance, the user may change their location, check-in to particular venues, look for available offers or perform other activities within the location-based system. At block 804, location-based system applies location-based activity to a credit card account. For example, the user may request an association of one or more selected offer(s) with a credit card account and those selected offers may be applied to the specific account. At block 805, process 800 ends.

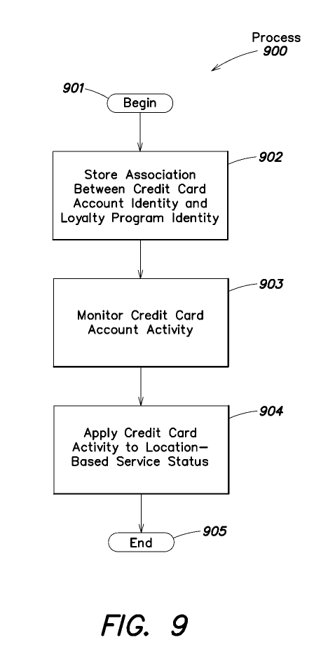

FIG. 9 shows a process for interacting between a credit card system in a location-based service according to one embodiment of the present invention. At block 901, process 900 begins. At block 902, a credit card system stores an association between a credit card account identity and a loyalty program identity. As discussed above, a credit card account identity may include a credit card and card holder username, or any other information that identifies a credit card account. A loyalty program identity may include, and the indication identifying a user within the location-based system. At block 903, the credit card system monitors credit card account activity. For instance, the user uses his/her credit card to make a qualifying purchase at a venue location defined in a location-based system. At block 904, the credit card system applies credit card activity to a location-based service status. For example, the user is automatically “checked-in” to the location-based on a transaction performed at the venue, the user is sent an indication that a particular offer is accepted and applied to the user's credit card account, or other action relating to the location-based service. At block 905, process 900 ends.

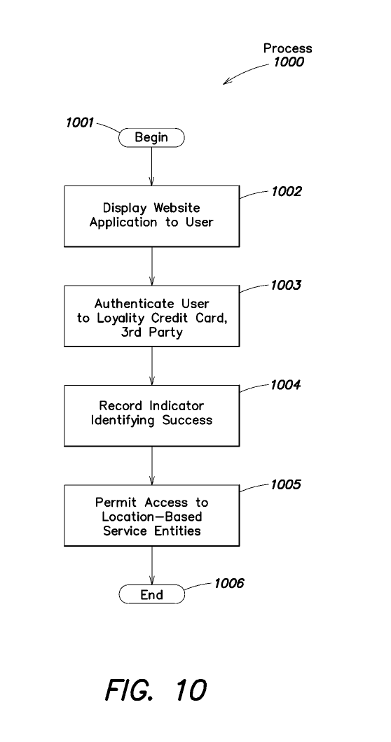

FIG. 10 shows an example process (e.g., process 1000) for authenticating to a service that uses location-based service resources in accordance with one embodiment. At block 1001, process 1000 begins. At block 1002, a website or other application (e.g., a location-aware application executing on the mobile device) may be displayed to the user. Such a website or other application may be, for example, a website operated by a loyalty program, credit card company, third-party offeror, or other service that is configured to create and manage resources in a location-based service. For instance, resources such as offers may be defined within the location-based service as more fully discussed below, and these offers may be accessed by users.

At block 1003, the users may be authenticated to a loyalty program, credit card program, third party provider, or other entity. In one implementation, a resource owner such as the loyalty program, credit card program, third party provider, or other entity may grant access by a client (e.g., a user) to particular defined offers in the location-based service without sharing a username and password defined at the loyalty program, credit card program, third party provider, or other entity's service. Rather, the client may authenticate directly to a server trusted by the location-based service (e.g., an authorization server) which issues an access token to the client to permit access to the location-based resource. Alternatively, an authorization server may be maintained by the loyalty program, credit card program, third party provider, or other entity's service. In one embodiment, the location-based service may use the OAuth 2.0 Authorization Protocol defined by IETF draft-ietf-oauth-v2-13 to permit users to access objects. However, it should be appreciated that other authentication protocols may be used.

At block 1004, the service records an indicator that identifies that the user has successfully authenticated. Such an indicator may be stored in a memory associated with a location-based service or a third party provider system. Notably, the indicator may be associated with a unique user identity of the user within the location-based service. This indicator may be used to unlock offers associated with particular venue locations. For instance, the location-based service may permit the user to access location-based service entities (e.g., offers) at block 1005. In one embodiment, after unlocking such offers, a user may be permitted to accept and/or redeem one or more of the unlocked offers. At block 1006, process 1000 ends.

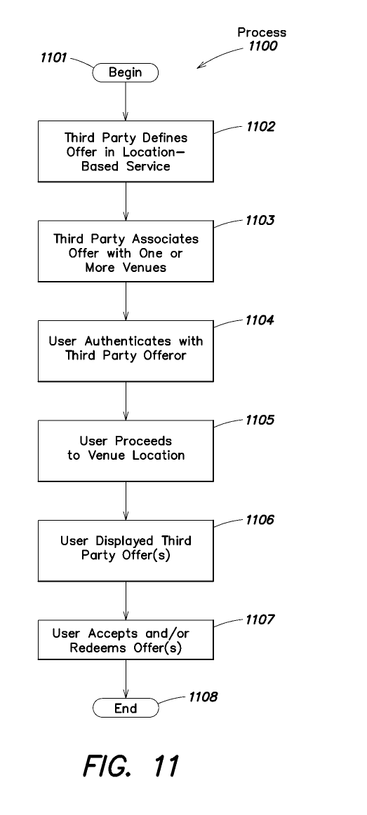

FIG. 11 is a block diagram showing an example process (e.g., process 1100) for processing and redeeming offers using a location-based service according to one embodiment of the present invention. At block 1101, process 1100 begins. At block 1102, a third party or other entity that integrates with the location-based service defines an offer within the location-based service. For instance, the location-based service may include a management interface, API or other interface with which the third party or any other entity may define offers. For one or more third parties or other entities, the location-based service may automatically import offers from the third party and make them available to users of the location-based service. For instance, such offers may be imported from a data feed, storage location, website, API, or other data source.

In one embodiment, a number of parameters may be defined on the offer, such as the offer name, information displayed to the user when the offer is unlocked (e.g., by checking in to a particular venue location), a type of offer depending on the status of the user (e.g., the “mayor” of a particular venue location), frequency the user visits the venue location (e.g., the offer is unlocked every X number of check-ins), the number of friends that check-in to a location, or other parameter. It should by appreciated that offers could be created by one of any number of entities, including, but not limited to merchants, credit card company, loyalty program provider, product or service producer, application provider, location-based service provider, or any other entity.

In one embodiment, the third party may create one or more offers that can be associated with a particular venue location defined in a memory associated with a location-based service (e.g., at block 1103). To this end, the location-based service may provide a management interface, API or other interface with which the third party or other entity may “attach” or otherwise associate defined offers to particular venue locations. Venues may be tracked by a venue identifier, which in one embodiment may be a unique identifier associated with a venue location. Parameters may be defined in relation to the attached offer, such as defining when the offer expires, when the offer is activated, among other criteria that may apply to the offer as defined on that particular venue location.

Once defined, the offer may be accepted by a user. According to one optional embodiment, the user is required to authenticate with a third party offeror or other entity prior to redeeming or purchasing any offers (or particularly designated offers). Optionally, at block 1104, the user authenticates with the third party offeror, location-based service, or other entity that provides an authentication service as discussed above with reference to FIG. 3. According to another embodiment, one criteria that may be required as a prerequisite for the user to view, accept, and/or redeem offers is that the user must be located near the venue location where the offers are redeemed. Such information may be determined by, for example, a mobile device and provided to the location-based service. For instance, location may be determined by one or more methods, including, but not limited to GPS, cell triangulation methods, WiFi, WLAN, Bluetooth, RFID, NFC, or other technologies or combinations of technologies.

At block 1105, the user proceeds to the venue location, such as a retail location where goods and/or services are sold. At block 1106, the user is displayed, on an interface of a mobile device, an indication of one or more offers made by the third party or other entity. A user may be permitted to select one or more of those offers to be accepted and/or redeemed (e.g., within an interface of a mobile device as discussed above). Alternatively, block 1106 may not be required, as the system may permit seamless acceptance of offers during a transaction (e.g., when the user “checks out” at the venue location). At block 1107, the user is permitted to accept and/or redeem the one or more offers. For instance, the user may select the offers to be accepted and/or redeemed within the interface of the mobile device, and those offers are associated with a transaction that the user is performing at the venue location. The defined offers may be permitted to be accepted and/or redeemed, according to one embodiment, when the user “checks in” to the venue location within the location-based service. In another embodiment, the user may be required to perform another action to accept and/or redeem the offer, such as, for example, selecting the offer to be redeemed within an interface of the mobile device, or by purchasing the offer and receiving a voucher. Such offers may be credited towards the current transaction, or may be provided to the user for use in a future transaction. At block 1108, process 1100 ends.

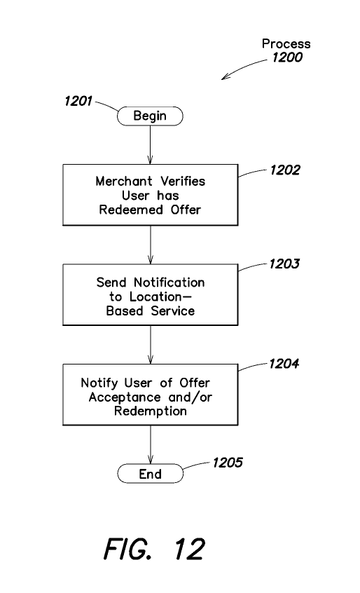

FIG. 12 is a block diagram showing an example process (e.g., process 1200) for verifying accepted and/or redeemed offers using a location-based service according to one embodiment of the present invention. At block 1201, process 1200 begins. At block 1202, a merchant verifies that a user has accepted and/or redeemed a particular offer. Such an offer may include an offer defined in a location-based service as discussed above. Responsive to the acceptance and/or redemption, a computer system associated with the merchant may send a notification to a location-based service (e.g., at block 1203), and the location-based service may in turn notify the user that the offer has been accepted and/or redeemed (e.g., at block 1204). Notably, the location-based service may be used to notify the user that the offer has been accepted and that the other may be, in one embodiment, applied to the current transaction. At block 1205, process 1200 ends.

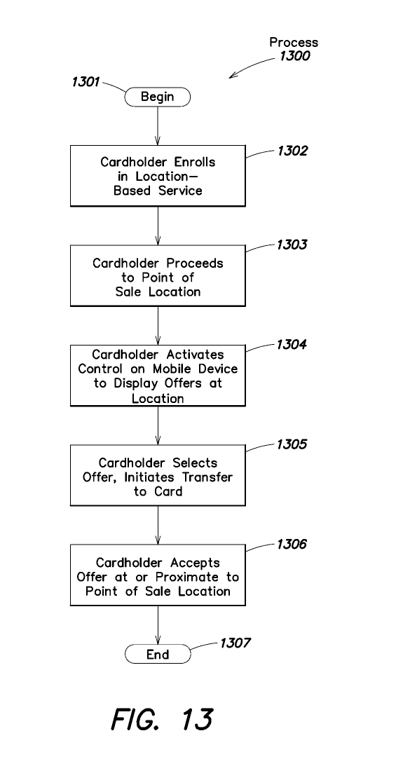

FIG. 13 is a block diagram showing an example process (e.g., process 1300) for redeeming or purchasing offers using a location-based service according to one embodiment of the present invention. At block 1301, process 1300 begins. In one embodiment, a credit card account holder is permitted to accept and redeem offers associated with credit card account holders. Such offers may be made available to credit card account holders through the location-based service. At block 1302, the cardholder enrolls in the location-based service. For instance, a website may permit a user to login using credentials of the cardholder, and enable an option that links the cardholder's identity (e.g., by credit card account number or other account identification) with the user's identity within the location-based service. Once identified with the location-based service as an authorized cardholder, that user may be permitted to view, accept, and/or redeem offers. For instance, at block 1303, the user (cardholder) proceeds to a point of sale location where the user can use his/her credit card or other payment instrument.

In one embodiment, if the user is not a cardholder, that user may be permitted to view offers (e.g., on an interface of a mobile device), but not accept or redeem them. The user may be provided an opportunity to become a cardholder in order to accept and/or redeem such offers, and the opportunity to accept and/or redeem such offers may result in increased cardholder memberships. In another embodiment, a user may not be capable of accepting and/or redeeming certain offers until the user/cardholder is authenticated as a cardholder.

At block 1304, the cardholder according to one embodiment activates a control on his/her mobile device that causes a display of offers available to be redeemed at the point of sale (e.g., the venue location as defined in the location-based service). As a prerequisite to viewing, purchasing, accepting, and/or redeeming particular offers, the user (cardholder) may be required to “check-in” to the venue location. In some embodiments, the user may be required to perform another action to redeem the offer, such as, for example, selecting the offer to be redeemed within an interface of the mobile device, or by purchasing the offer and receiving a voucher. At block 1305, the cardholder selects one or more offers to be redeemed (e.g., within an interface presented to the user in a display of the mobile device). Further, once selected, the offers may be “transferred” to the user's credit card or other payment instrument, in that the offers are then associated with the credit card account. At block 1306, the cardholder may use the card at the point of sale location to purchase goods or services, and accept any offers which may apply to the transaction. At block 1307, process 1300 ends.

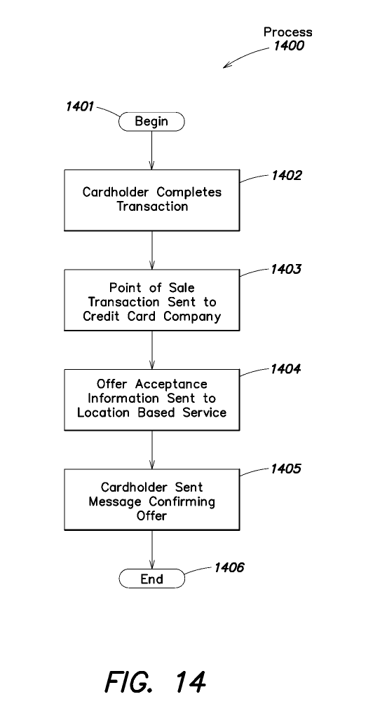

FIG. 14 is a block diagram showing an example process (e.g., process 1400) for redeeming credit card offers using a location-based service according to one embodiment of the present invention. At block 1401, process 1400 begins. At block 1402, a cardholder completes a transaction involving an offer that was previously associated with the user's card or otherwise generally applied to a credit card program. Such an association may be stored in a memory of a system of a location-based service. To complete a transaction, for instance, at the point of sale location, the cardholder “swipes” his/her credit card at a card reader device. The transaction is cleared, and point of sale transaction information is sent to the credit card company (e.g., a computer system that handles transactions) at block 1403 over a communication network. The credit card company system communicates offer acceptance information to the location-based service (e.g., at block 1404). At block 1405, the location-based service sends a message to the user (e.g., via the user's mobile device) confirming that the offer has been accepted and applied to the user's account. In this way, the user may be notified separately and independently from the merchant sale transaction systems that the credit card offer was successfully applied to a particular transaction.

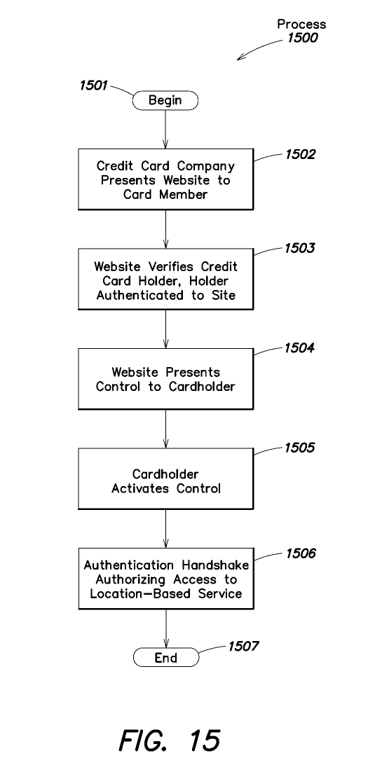

FIG. 15 shows a process 1500 for authorizing access by a location-based service to a credit card account. At block 1501, process 1500 begins. At block 1502, a credit card company presents a website to a cardmember. For instance, a website interface may be provided that allows the cardmember to access their account information and configure access to their account. For instance, the cardmember may provide authentication information such as a username and/or password to gain access. Other information for authenticating the user may also be used.

At block 1503, the website verifies the credit card holder in the credit card holder is authenticated to the website. In one embodiment, the website may include a control that when presented to the user (e.g., at block 1504), allows the user to authorize access to an application or service, such as a location-based service. At block 1505, the cardholder activates a control (e.g., a button or other user interface control) that when activated, initiates an authentication handshake authorizing access to a location-based service (e.g., at block 1506). For instance, authorization information may be stored at a credit card system that allows access to particular information relating to the credit card account by the location-based service. It should be appreciated also that the authentication handshake may be performed earlier in the process (e.g., prior to or at block 1503). At block 1507, process 1500 ends.

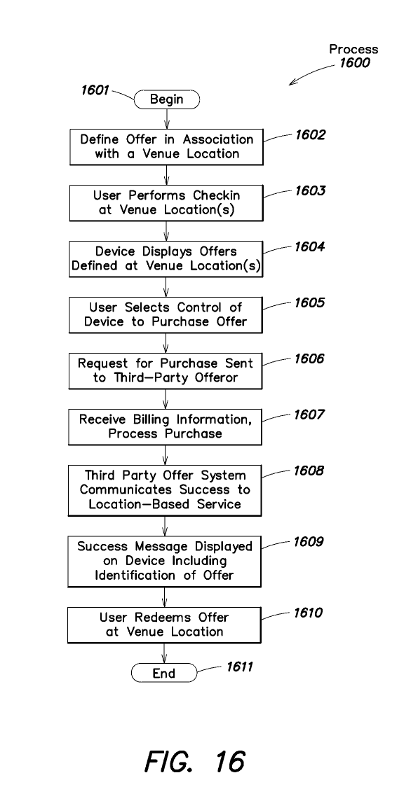

FIG. 16 shows a process 1600 for processing purchases of third-party offers using a location-based service. At block 1601, process 1600 begins. At block 1602, an offer as defined in association with a venue location. For instance, a venue owner may be permitted to define one or more offers within a location-based service. In one implementation, the venue owner may define offers using a user interface to a venue management website that permits the creation an association of offers to particular venues. In another implementation, offers may be imported by the location-based service such as from an offer provider (e.g., the well-known Groupon offer site). In yet another implementation, an API may be provided that permits applications to create offers and associate them with venues within the location-based service.

At block 1603, a user performs a check in at one or more particular venue locations. For instance, in a location-based service, that user may select a control that allows the user to check in to one or more venues. According to one embodiment, the location-based service may display offers at a venue once a user is checked in to the location. For instance, at block 1604, a mobile device may display offers defined at the venue location to the user within the display.

At block 1605, a user optionally selects a control presented within the interface of the device to purchase a particular offer. In another embodiment, the user does not need to affirmatively accept the offer (e.g., by selecting a control), but can perform another action such as by making a qualifying purchase at the venue location. At block 1606, a request is sent from the location-based service to a third party offeror. For instance, the location-based service may send a message to a system associated with the third party offeror. The third party offer system may indicate in return that the particular offer may be purchased, and may send such an indication to the location-based service. At block 1607, the user may enter billing information on the device, or the system may otherwise transmit any billing information to the third party offer system for purchasing the offer selected by the user. In one embodiment, such billing information may be preloaded or otherwise associated with the user prior to any of these steps. For instance, the billing information may be obtained prior to offer display and/or loading. At block 1608, the third party offeror system communicates information indicating success to the location-based service, and success information is displayed at the user device. For instance, at block 1609, a success message may be displayed on the user device including identification of the offer that was purchased.

The user may then proceed to redeem the purchased offer at the venue location at block 1610. In one embodiment, information displayed within the device may be used to redeem the offer at the venue location. For instance, a bar code or other proof of purchase information may be used or presented at the venue location for the user to receive goods or services. At block 1611, process 1600 ends.

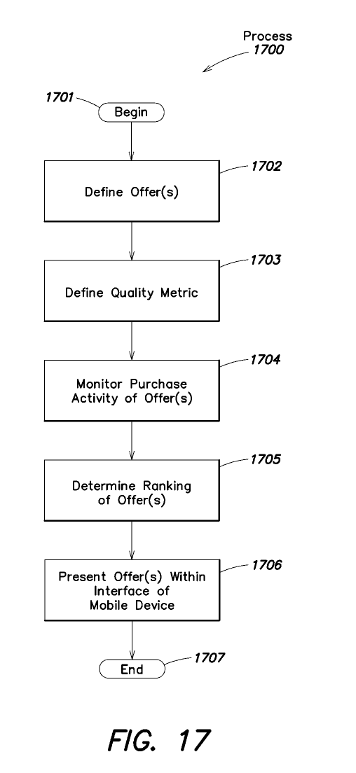

FIG. 17 shows a process 1700 for presenting offers to users in accordance with one embodiment of the present invention. At block 1701, process 1700 begins. At block 1702, one or more offers are defined within for instance a location-based service. Such offers may be defined in many ways as discussed above. At block 1703, a quality metric is defined that permits the user to filter the offers received within the interface of the device. For instance, a user may only want to see the best offers that are applicable to that user. In one embodiment, the quality metric may be a numerical ranking of particular offers, and the user may be permitted to select a particular level of quality metric so that offers having a minimum level of the quality metric may be shown within the device interface. In another embodiment, the location-based service automatically selects and ranks offers that are presented to a particular user. In one implementation, offers are ranked without user intervention.

According to one embodiment, the metric may relate to one or more parameters that are tracked by the location-based service. For instance, a quality metric may relate to the number of times a particular offer has been purchased by other users, such as users within the user's social network. Offers may also be ranked based on the amount of purchases of the offer that have occurred within a fixed amount of time (e.g., a conversion rate of the offer measured over the last 4 hours, 8 hours, 24 hours, etc.). Offers may also be ranked based on the value that they may provide to a particular user. For instance, offers may be ranked according to a percentage savings or amount of money saved. In one embodiment, a personalized ranking signal may be determined for a particular user based on information relating to that user. In this way, offers may be selectively presented to the particular user so that they are more likely to be accepted by that user. Further, because in some embodiments such offers are presented on a mobile device (e.g., a phone) that has limited display area, it is appreciated that such offers should be highly targeted to that user.

At block 1705, the location-based system determines a ranking of one or more offers, and such offers as ranked are presented within the interface of the mobile device at block 1706. At block 1707, process 1700 ends.

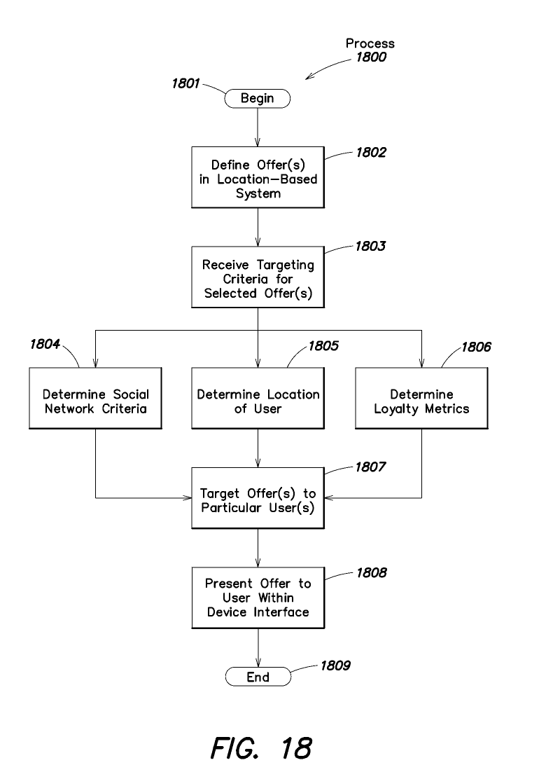

FIG. 18 shows a process 1800 targeting offers to users according to one embodiment of the present invention. At block 1801, process 1800 begins. At block 1802, one or more offers are defined within a location-based system. As discussed above, offers may be created in a number of ways and associated with particular venue. At block 1803, a user associated with a particular venue is capable of creating offers within the location-based system. This may be accomplished, for instance, using a management interface, API, or other interface associated with the location-based service.

At block 1803, the location-based system receives targeting criteria for one or more selected offers. According to one embodiment, the user may define criteria that when evaluated, causes a particular offer to be made to a user of the location-based system. For instance, when particular criteria are fulfilled, an indication of an offer is displayed within an application interface of the location-based system (e.g., as presented on an interface of a mobile device).

As discussed, one or more criteria may be used to determine whether a particular offers targeted to a particular user. At block 1804, the location-based system determines social network criteria associated with the user. For instance, the system may be able to determine whether certain deals have been targeted to particular users in that user's social network. In one example, using Twitter, offers may be sent to followers of a particular user, or offers may be sent to friends of particular followers. In one embodiment, an offer may be matched to a user and if the user accepts or purchases that particular offer, that offer may be extended to other users as determined by the location-based system.

The block 1805, the location-based system may determine the location of the user. Based on that person's location, particular offers may be targeted to that user. Location information along with other information may be used to determine whether or not that user receives a particular offer. For instance, as discussed above, particular offers may be targeted to particular users based on criteria associated with each respective user. The user criteria may include, without limitation, demographic information (e.g., residence information, income, gender, age, etc.), behavioral information of the user (e.g., check-in history, purchase history, offer acceptance history, etc.), psychographic information (e.g., interests, opinions, information relating to user values, etc.), among other types of user information, either alone or in combination with any data. At block 1806, the location-based system may also determine one or more loyalty metrics that are used to target particular offers to particular users.

At block 1807, the location-based system targets one or more offers to particular users. According to one embodiment, the system at block 1808, presents an offer to the user within the device interface. This may be done, for example, in association with a venue where the user has checked in. For instance, there may be a user interface element that displays offers associated with a particular venue. Further, depending on whether the offers are targeted to that particular user, certain offers may be displayed to the user within the interface. At block 1809, process 1800 ends.

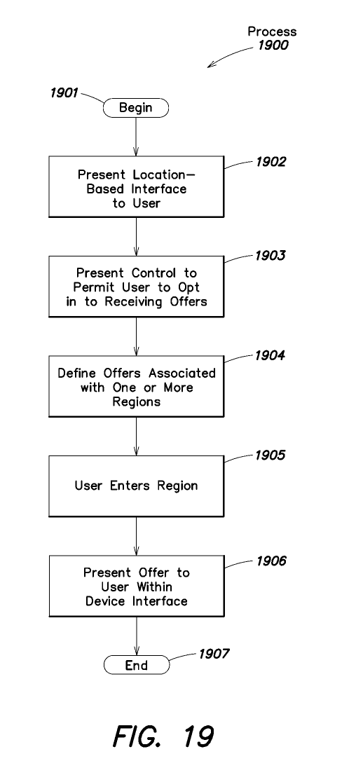

FIG. 19 shows a process 1904 permitting the user to control whether or not the user receives offers from a location-based system according to one embodiment of the present invention. At block 1900, process 1900 begins. At block 1902, a location-based interfaces present to the user. For instance, the interface may be provided to a user via a website, a user device, or other computer system that permits the user to control whether or not the user will receive offers. For example, a user device may be configured to present a user interface control to allow the user to opt in to receiving offers on that particular user device (e.g., at block 1903).

At block 1904, a venue operator or other user may define offers associated with one or more regions. These regions may be set location areas or may be a location that is relative to another particular location (e.g., the location of the user at a particular point in time, within X feet of the current location of the user, within X miles of the venue location, etc.). According to one embodiment, a venue operator that defines offers associated with his/her location may be permitted to define the location area in which a particular offer is triggered. This may be accomplished, for example, within a management interface within which venue operators define offers that are presented to users.

At block 1905, a user enters a particular region (e.g., within a particular distance of a venue location), and at block 1906, the location-based system presents an offer to the user within a device interface. For instance, if the location-based application is currently executing within the interface, an indication may be provided that notifies a user of an offer that can be redeemed. In another embodiment, where the location-based application is not currently executing, the notification may be provided by the device (e.g., a message, pop-up window, or other notification type) indicating an offer to the user. Notably, because notifications may be based at least in part on the location of the user, location data may be used to filter what offers are provided. In one example, when the user is near a particular location, the location-based service may send push notifications to that user. In yet another embodiment, recommendations may be provided to the user based on the user's location relative to the location of the venue relating to the recommendation.

In another implementation, if a user opts-in to receiving notifications, the user's device will send the location-based service the location of the device from time to time. For instance, the device may send an updated location to the location-based service after the user moves a specific distance. In one implementation, notifications are based on the user's interaction with regions. In one example, the device includes a process that monitors the user's location (referred to herein as a location manager process (such as provided in an iPhone OS by Apple Computer)) that persists between launches of an application (e.g., a location-based application). If a region crossing occurs while the user's application is not running, the system may automatically wake up the application (or relaunches the application) in the background so that the application can process the event. When relaunched, all of the regions configured previously are made available in a property of any location manager objects that are created.

Therefore, when the user moves a set distance, the application (e.g., the location-based application residing on the user device) will wake up and the location will be sent to the location-based service. The location-based service then sends the user push notifications about interesting things nearby (e.g., friends checked-in, things on the user's “to do” list, and offers located nearby). As discussed, such offers may be created in the location-based service, or may be third-party offers provided by one or more systems that provide offers (e.g., Groupon, LivingSocial, American Express, etc.). At block 1907, process 1900 ends.

### Example Computer Implementations

Processes described above are merely illustrative embodiments of systems that may create and manage offers in association with a location-based service. Such illustrative embodiments are not intended to limit the scope of the present invention, as any of numerous other implementations for performing the invention. None of the claims set forth below are intended to be limited to any particular implementation of a method of offers in a location-based system, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate extending offers to users and redeeming offers according to various embodiments of the invention. Further, the software design system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS X Snow Leopard, MAC OS X Lion operating systems available from Apple Computer, the Solaris Operating System available from Sun Microsystems, iOS, Blackberry OS, Windows 7 Mobile or Android OS operating systems, or UNIX available from various sources. Many other operating systems may be used.

Some aspects of the invention may be implemented as distributed application components that may be executed on a number of different types of systems coupled over a computer network. Some components may be located and executed on mobile devices, servers, tablets, or other system types. Other components of a distributed system may also be used, such as databases (e.g., the mongoDB database available from 10gen, Inc.) or other component types.

The processor and operating system together define a computer platform for which application programs in high-level programming languages are written. It should be understood that the invention is not limited to a particular computer system platform, processor, operating system, or network. Further, it should be appreciated that multiple computer platform types may be used in a distributed computer system that implement various aspects of the present invention. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). Certain aspects of the present invention may also be implemented on a cloud-based computer system (e.g., the EC2 cloud-based computing platform provided by Amazon.com), a distributed computer network including clients and servers, or any combination of systems.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of distributed system 100, each of the components may reside in one or more locations on the system. For example, different portions of the components of system 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

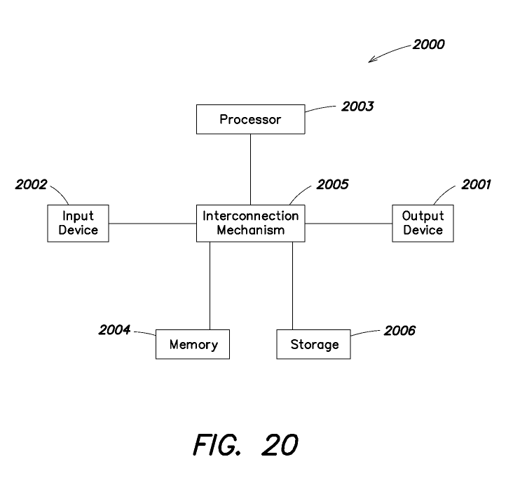

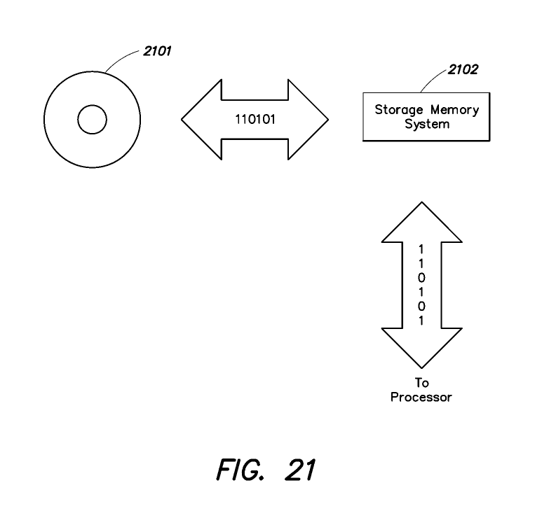

Any number of systems of distributed system 100 may be implemented on a computer system described below in relation to FIGS. 20 and 21. In particular, FIG. 20 shows an example computer system 2000 used to implement various aspects. FIG. 21 shows an example storage system that may be used.

System 2000 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the location-based services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 2000 such as that shown in FIG. 20. The computer system 2000 may include a processor 2003 connected to one or more memory devices 2004, such as a disk drive, memory, or other device for storing data. Memory 2004 is typically used for storing programs and data during operation of the computer system 2000. Components of computer system 2000 may be coupled by an interconnection mechanism 2005, which may include one or more busses (e.g., between components that are integrated within a same machine) and/or a network (e.g., between components that reside on separate discrete machines). The interconnection mechanism 2005 enables communications (e.g., data, instructions) to be exchanged between system components of system 2000. Computer system 2000 also includes one or more input devices 2002, for example, a keyboard, mouse, trackball, microphone, touch screen, and one or more output devices 2001, for example, a printing device, display screen, and/or speaker. In addition, computer system 2000 may contain one or more interfaces (not shown) that connect computer system 2000 to a communication network (in addition or as an alternative to the interconnection mechanism 2005.

The storage system 2006, shown in greater detail in FIG. 21, typically includes a computer readable and writeable nonvolatile recording medium 2101 in which signals are stored that define a program to be executed by the processor or information stored on or in the medium 2101 to be processed by the program. The medium may, for example, be a disk or flash memory. Typically, in operation, the processor causes data to be read from the nonvolatile recording medium 2101 into another memory 2102 that allows for faster access to the information by the processor than does the medium 2101. This memory 2102 is typically a volatile, random access memory such as a dynamic random access memory (DRAM) or static memory (SRAM). It may be located in storage system 2006, as shown, or in memory system 2004, not shown. The processor 2003 generally manipulates the data within the integrated circuit memory 2004, 2102 and then copies the data to the medium 2101 after processing is completed. A variety of mechanisms are known for managing data movement between the medium 2101 and the integrated circuit memory element 2004, 2102, and the invention is not limited thereto. The invention is not limited to a particular memory system 2004 or storage system 2006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 2000 is shown by way of example as one type of computer system upon which various aspects of the invention may be practiced, it should be appreciated that aspects of the invention are not limited to being implemented on the computer system as shown in FIG. 20. Various aspects of the invention may be practiced on one or more computers having a different architecture or components that that shown in FIG. 20.

Computer system 2000 may be a general-purpose computer system that is programmable using a high-level computer programming language. Computer system 2000 may be also implemented using specially programmed, special purpose hardware. In computer system 2000, processor 2003 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS X Lion operating systems available from Apple Computer, the Solaris Operating System available from Sun Microsystems, iOS, Blackberry OS, Windows 7 Mobile or Android OS operating systems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

### Example Implementations

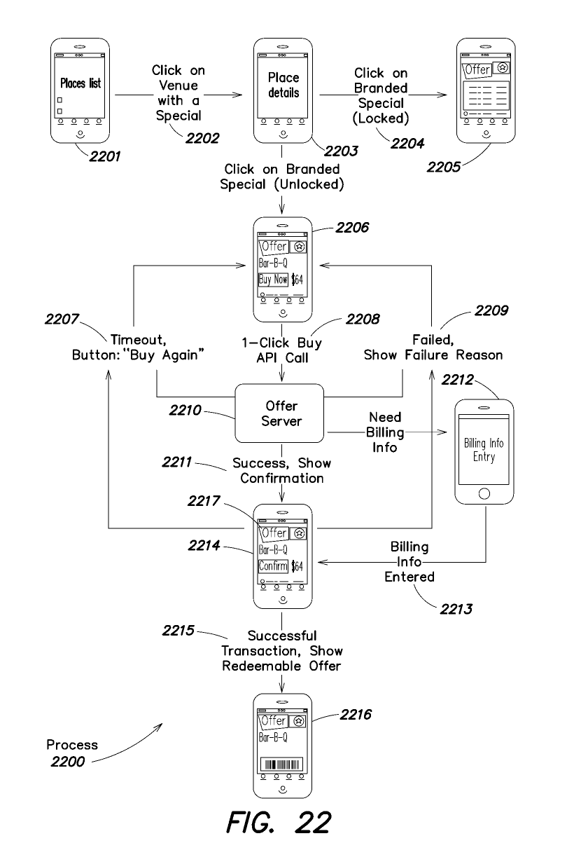

Below are several implementations according to various embodiments of the present invention. In particular, FIG. 22 shows one example implementation of a process 2200 where the offers may be purchased in redeemed using a mobile device. For instance, a user utilizing a mobile device may be displayed in a list of places 2201 that identifies venues near the user. At 2202, a user selects (e.g., clicks on) a venue having an offer (e.g., a “special”) defined for that particular venue. When selected, at 2203, information regarding the venue is displayed to the user.

At 2204, the user selects a branded special associated with particular venue. However, in 2204, the location-based service may prohibit a particular offer from being redeemed if the user has not checked in to the venue, or has satisfied some other criteria for redeeming a particular offer (e.g., the user has not logged into the service, the user has not provided authentication information for an offer server, the user does not belong to a particular loyalty program, among other criteria). At 2205, the particular offer may be indicated to the user on the device is being locked, and therefore cannot be redeemed.

If checked in, the user may select a branded special that is unlocked and may proceed to purchase the offer at 2206. At 2208, a method of buying the application by selecting a control within the user face of the mobile device may be performed. For instance, the user may be provided a one-click control that permits the user to purchase the offer with a single input. According to one embodiment, the location-based service sends a purchase request to an offer server 2210 that processes the offer purchase. The request can timeout, and a button may be displayed that permits the user to buy the offer again at 2207. The purchase may fail for some particular reason at 2209, and a message may be displayed to the user. If billing information is not already known by the device at 2210, the user device may display a billing information entry interface 2212 where billing information is entered (e.g., at 2213).

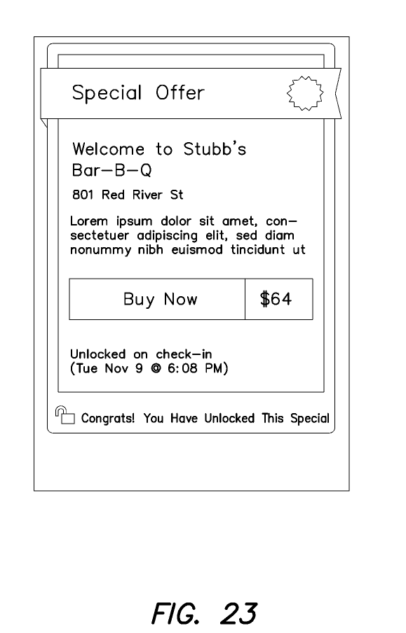

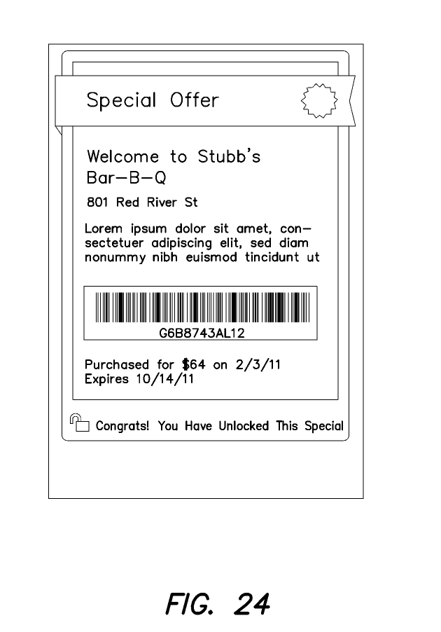

If the purchase is successful at 2211, a confirmation may be displayed to the user on the mobile device at 2214. Further, if the transaction is successful, a redeemable offer may be shown on the display of the mobile device (e.g., at 2215). FIG. 23 shows one example interface that may be displayed to the user from a location-based service application of a mobile device according to one embodiment of the present invention. In another implementation, the device may show within the interface (e.g., 2216) information identifying the purchased offer along with information that may allows the user to redeem the offer at the venue location. For instance, a bar code may be shown identifying the purchase that when scanned at the venue location, allows the user to receive the goods or services associated with a particular offer. For instance, FIG. 24 shows another example interface of a mobile device where the purchased offer includes a bar code that may be scanned at the merchant location. The offer display may include other identifying information, such as, for example, an offer code, serial number or other information that would allow a merchant to verify the offer.

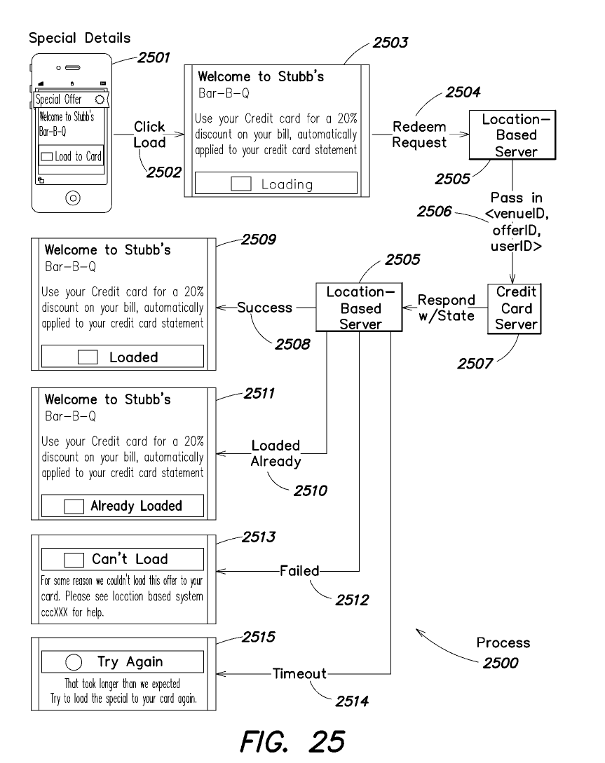

FIG. 25 shows a process 2500 for redeeming offers associated with a credit card account in processing such offers using a location-based system. In the example shown, one or more offers may be displayed to the user at a mobile device 2501. In one embodiment of the present invention, the user device includes a control that allows a user to associate a particular offer with a particular credit card account. In one implementation, the control “loads” a selected offer (e.g., at 2502) to credit card. It should be appreciated, however, that such a capability may be used with a loyalty account, user account, particular mobile device of the user, system, or other identity of the user.

At 2503, the display of the user device may indicate that a particular offer is being associated with a credit card along with any details of the offer. At 2504, the user redeems the request and a notification is sent to a location-based server 2505. Information relating to the offer to be associated with a particular credit card account is sent to a credit card server 2507. In one example, the information may include a venue identifier, an offer identifier, a user identifier for the credit card server, among other information related to the offer.

The credit card server responds with the state of the redemption request for that particular offer to the location-based service 2505. The location-based server may indicate success 2508 to the user within an interface (e.g., 2509) identifying that the offer will be automatically applied to a credit card statement associated with the cardholder. The location-based server may also indicate that the offer is loaded already onto the credit card account (e.g. at 2510), and may display an indicator to the user within the device interface (e.g., 2511). Further, the location-based server may indicate that the requested failed (2512) and that the system could not associate the offer with the particular card. An indication may be provided to the user within the interface (2513) that the offer could not be associated with the card. Further, the location-based server may indicate that the request has timed out (2514) and that the user should attempt to upload the offer to their card again (2515).

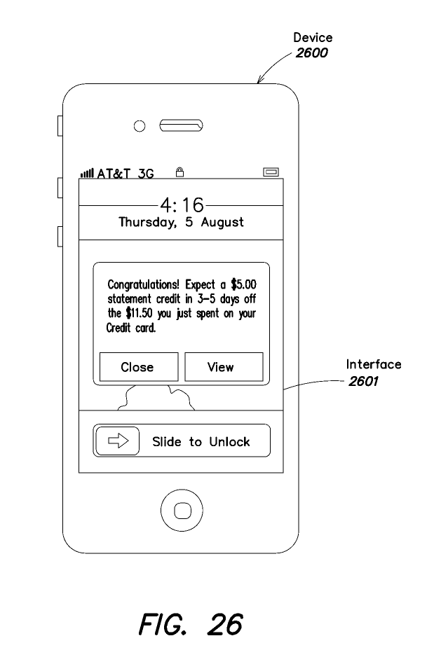

After a user has successfully associated an offer with a particular credit card, that user may use the credit card to make a qualifying purchase at a particular location. Once the credit card company receives details regarding the transaction, that offer may be applied to the user's credit card account automatically. In yet another embodiment, an indication may be sent to a user of a location-based service when the particular offer is redeemed and applied to the user's credit card account. FIG. 26 shows an interface 2601 of the device 2600 that displays such an indication to the user. The indication may include information relating to the offer such as the discount applied to a particular user's account and any other related information.

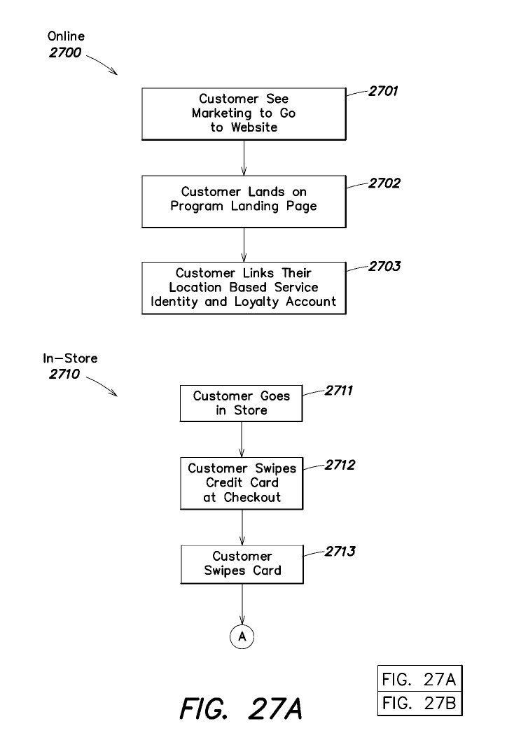

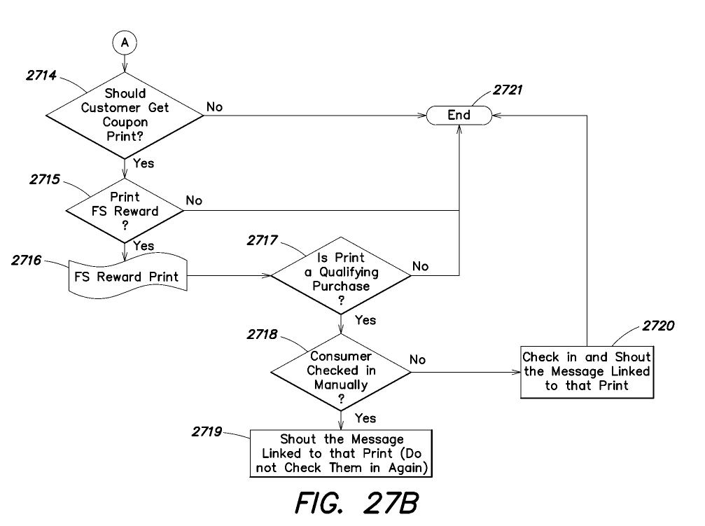

FIGS. 27A-27B show an embodiment of a loyalty program integrated with a location-based service according to one embodiment of the present invention. There may be an online 2700 component of the loyalty program process where a particular user (e.g., a customer of a vendor having a loyalty program) goes to a website (e.g., at 2701) and the customer is directed to a particular landing page (e.g., at 2701) associated with a loyalty account. For instance, there may be a loyalty program associated with a particular vendor, venue location, or other provider of goods and/or services. That customer may access the website to access loyalty program information, account details, redeem offers, or perform other functions and receive other information.

At 2703, the customer links their location-based service identity (e.g., a username, device identifier, and/or other information) with a loyalty account. This may be accomplished, for instance, by providing a control, that when selected, allows the customer to provide information regarding a location-based service identity to a loyalty account system and associate that identity with the loyalty program identity (e.g., a loyalty program username, ID, account number, home or mobile phone number or other identification information). The information may also allow the user to specify particular parameters related to the link, such as preferences of the user relating to opting in to receive offers, notifications, emails, or other communications between systems.

There may be an in-store 2710 component of the loyalty program process where a particular customer goes to the store (e.g., at 2711) to make purchases and redeem particular offers. At 2712, the customer swipes his/her credit card at a checkout along with the customer's loyalty card (e.g., at 2713). At 2714, it is determined whether the customer should get one or more coupon offers printed at the redemption location. If it is determined that an award should be printed at the redemption location (e.g., 2715), then an award is printed (e.g., 2716). It may also be permitted for a customer to instantly redeem an award if a qualifying purchase is made during the current transaction. If the printed award is a qualifying purchase, then the award may be applied to the transaction.

In one embodiment, it may determined whether the customer is “checked-in” to the venue (e.g., at 2718) within the location-based service. In one embodiment, if the user is not checked in (2720), the location-based system automatically checks the user in and sends a message to the user regarding that particular printed award so that they are aware that the award may apply to the current transaction. If it is determined that the user is already checked in, at 2719, the user may be notified that the award may be redeemed. Notably, because the loyalty program identity and the location-based service identity are linked, the customer's use of one of the identities may be updated in the other. For instance, a swipe of a loyalty club card at a particular venue location may cause the user to be automatically checked-in to that venue within the location-based service. At 2721, process 2710 ends.

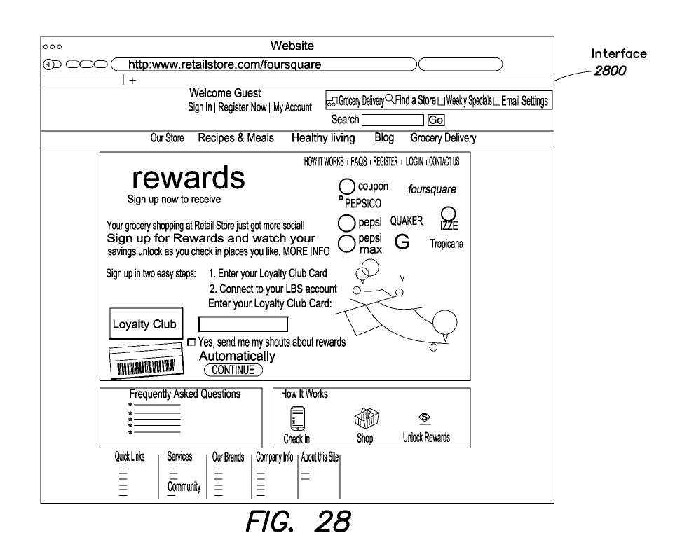

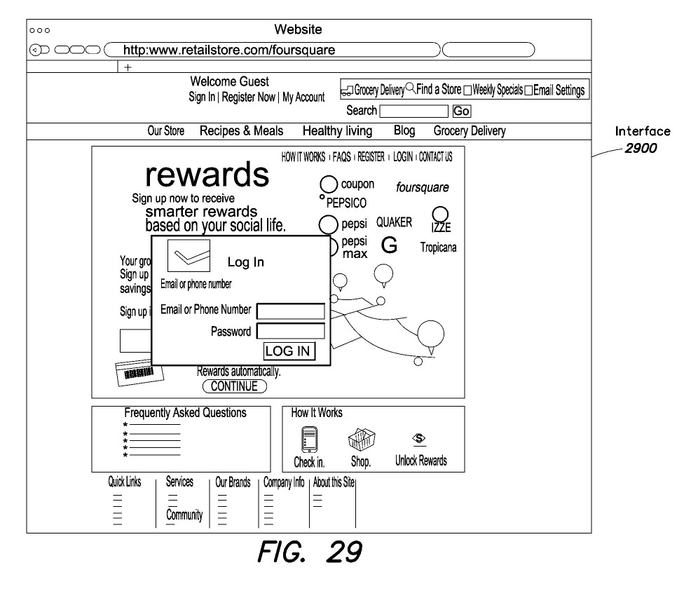

FIG. 28 shows an example website interface 2800 for use with a loyalty program in accordance with one embodiment of the present invention. For instance, there may be defined a loyalty program in association with a retail store. In one embodiment, a landing page may be provided that allows a customer to link a loyalty club account with a location-based service (LBS) identity. In one embodiment, the loyalty club member inputs their loyalty program identifier and any authentication information (e.g., the member “logs in” to their account in an interface of the website such as that shown in FIG. 29 (interface 2900)). Once authenticated, the member is permitted to enter an identifier of a location-based-service account (e.g., a username, unique identifier, device identifier, or other identifier type) to which the member is associated. The user identifier or other information may be stored by the loyalty program server to permit the location-based application to communicate and perform functions within the loyalty system.

In one embodiment, the user is permitted to check in to the venue, shop for items at the location, and unlock rewards. Such rewards may be printed at the venue (e.g., via a printer located at the check-out such as a Catalina printer), received through the location-based service (e.g., within an interface of the device, such as a popup or message), or may be applied directly to the user's loyalty account. For instance, when the user swipes his/her card at the venue location, that member may receive the award. In another embodiment, the member receives an indication of the award within an application associated with the location-based service. For instance, a notification is displayed in an interface of a mobile device. Many other embodiments may be possible, such as applying a particular offer to a credit card statement in addition to any loyalty program savings for the transaction. In this way, offers may be applied and redeemed in real time, without the necessity of the user knowing apriori what items that he/she would like to purchase, clipping coupons for particular deals ahead of time, and redeeming the deals at the merchant location.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for processing an offer, the method comprising acts of:
storing, in a distributed computer system of a location-based service, at least one offer;
associating the at least one offer with a credit card program;
determining a location of a mobile device associated with a user;
determining that the determined location is proximate to a venue at which the at least one offer is available;
presenting, to the user in a display of the mobile device associated with the user, an indication of the at least one offer responsive to the act of determining that the determined location is proximate to a venue at which the at least one offer is available; and
permitting the user to accept the offer.

2. The method according to claim 1, further comprising an act of storing an indication in the distributed computer system of the location-based service, the indication identifying that the user is checked in to the venue.

3. The method according to claim 1, wherein the act of presenting the indication of the at least one offer is responsive to an act of providing a control of the mobile device that, when activated, displays one or more offers that are capable of being accepted at the location of the mobile device.

4. The method according to claim 1, further comprising an act of associating an identity of the user in the location-based service with an identity of the user in the credit card program.

5. The method according to claim 3, wherein one or more offers are displayed only if the user is an authorized account holder in the credit card program.

6. The method according to claim 4, further comprising an act of permitting the user to select, within the display of the at least one offer, a control that associates the at least one offer with the identity of the user in the credit card program.

7. The method according to claim 6, further comprising an act of storing, by the distributed computer system of a location-based service, an indication of the association of the at least one offer associated with the identity of the user in the credit card program.

8. The method according to claim 7, further comprising an act of accepting, from the user at the venue, the identity of the user in the credit card program, retrieving the indication of the association of the at least one offer associated with the identity of the user in the credit card program, and applying the at least one offer to a transaction involving the user at the venue.

9. The method according to claim 8, wherein the act of accepting, from the user at the venue, the identity of the user in the credit card program comprises an act of scanning a credit card at the venue.

10. The method according to claim 8, further comprising an act of sending, by a computer system associated with the venue to the distributed computer system of the location-based service, an indication that the at least one offer was accepted.

11. The method according to claim 10, further comprising indicating, to the user in the display of the mobile device, the indication that the at least one offer was accepted.

12. The method according to claim 1, further comprising applying, by a computer system operated by a credit card company, the at least one accepted offer to a credit card associated with the user.

13. The method according to claim 1, further comprising an act of permitting the user to accept the at least one offer using the mobile device.

14. The method according to claim 13, further comprising an act of permitting the user to accept the at least one offer at the venue.

15. The method according to claim 13, further comprising an act of indicating to the user in the display of the mobile device an acceptance of the at least one offer.

16. The method according to claim 15, further comprising an act of permitting the user to fulfill the acceptance of the at least one offer at the venue responsive to the display of the acceptance of the at least one offer.

17. The method according to claim 16, further comprising acts of displaying information relating to the acceptance of the at least one offer and using, at the venue, the displayed information to fulfill the acceptance of the at least one offer.

18. The method according to claim 13, further comprising an act of permitting the user to execute a purchase associated with the at least one offer using the mobile device.

19. A system for processing an offer, the system comprising:
a location-based service including a distributed computer system having at least one processor and a memory;
a component for storing, in the memory, at least one offer;
a component for storing, in the memory, an association of the at least one offer with a credit card program;
a component for determining a location of a mobile device associated with a user;
a component that determines that the determined location is proximate to a venue at which the at least one offer may be accepted;
a display component configured to present, to the user in a display of the mobile device associated with the user, an indication of the at least one offer responsive to determining that the determined location is proximate to a venue at which the at least one offer may be accepted; and
a component that permits the user to accepted the offer.

20. The system according to claim 19, further comprising a component configured to store an indication in the memory of the distributed computer system of the location-based service, the indication identifying that the user is checked in to the venue.

21. The system according to claim 19, wherein the display component configured to present the indication of the as least one offer is responsive to a control of the mobile service that, when activated, displays one or more offers that are capable of being accepted at the location of the mobile device.

22. The system according to claim 19, further comprising a component configured to associate an identity of the user in the location-based service with an identity of the user in the credit card program.

23. The system according to claim 21, wherein one or more offers are displayed only if the user is an authorized account holder in the credit card program.

24. The system according to claim 22, further comprising a component that permits the user to select, within the display of the at least one offer, a control that associates the at least one offer with the identity of the user in the credit card program.

25. The system according to claim 24, further comprising a component for storing, in the memory of the distributed computer system of the location-based service, an indication of the at least one offer associated with the identity of the user in the credit card program.

26. The system according to claim 25, further comprising a component configured to accept, from the user at the venue, the identity of the user in the credit card program, a component configured to retrieve the indication of the association of the at least one offer associated with the identity of the user in the credit card program, and a component configured to apply the at least one offer to a transaction involving the user at venues.

27. The system according to claim 26, wherein the component configured to accept the identity of the user in the credit card program comprises a scanner configured to scan a credit card at the venue.

28. The system according to claim 26, further comprising a component of a computer system associated with the venue, the component being configured to send to the distributed computer system of the location-based service, an indication that the at least one offer was accepted.

29. The system according to claim 28, further comprising a component adapted to indicate, to the user in the display of the mobile device, the indication that the at least one offer was accepted.

30. The system according to claim 19, further comprising a component adapted to apply the as least one accepted offer to a credit card account associated with the user.
